(19) United States
(12) Patent Application Publication
(10) Pub. No.: US 2023/0180988 A1
(43) Pub. Date: Jun. 15, 2023

(54) ROBOT CLEANER AND METHOD OF CONTROLLING ROBOT CLEANER

(71) Applicant: LG ELECTRONICS INC., Seoul (KR)

(72) Inventors: Yonggil SHIN, Seoul (KR); Jinwook SEO, Seoul (KR); Gayeon KIM, Seoul (KR)

(73) Assignee: LG ELECTRONICS INC., Seoul (KR)

(21) Appl. No.: 17/920,981

(22) PCT Filed: Apr. 23, 2021
(86) PCT No.: PCT/KR2021/005147

§ 371 Date: Oct. 24, 2022

(30) Foreign Application Priority Data
Apr. 24, 2020 (KR) 10-2020-0050233

(51) Int. Cl. A47L 11/40; A47L 11/282; G05D 1/02

(52) U.S. Cl. CPC A47L 11/4011; A47L 11/4061; A47L 11/282; A47L 11/4038; A47L 11/4066; G05D 1/0274; A47L 2201/04; G05D 2201/0203

(57) ABSTRACT

The present disclosure relates to a method of controlling a robot cleaner including a pair of rotary plates having lower sides to which mops facing a floor surface are coupled, the robot cleaner being configured to move by rotating the pair of rotary plates, the method including: a region setting step of setting a cleaning region on the floor surface; and a movement step of moving the robot cleaner in the cleaning region, in which the region setting step divides the cleaning region into a plurality of divided regions, and the plurality of divided regions at least partially overlaps one another, such that it is possible to clean an entire cleaning region and repeatedly clean a particular region.

### TECHNICAL FIELD

The present disclosure relates to a robot cleaner and a method of controlling the robot cleaner, and more particularly, to a robot cleaner capable of rotating a mop of the robot cleaner and moving and cleaning a floor using a frictional force between the mop and the floor, and a method of controlling the robot cleaner.

### BACKGROUND ART

Recently, with the development of industrial technologies, a robot cleaner has been developed which performs a cleaning operation while autonomously moving in a zone required to be cleaned without a user's manipulation. Such a robot cleaner has a sensor capable of recognizing a space to be cleaned, and a mop capable of cleaning a floor surface, such that the robot cleaner may move while wiping, with the mop, the floor surface in the space recognized by the sensor.

Among the robot cleaners, there is a wet robot cleaner capable of wiping a floor surface with a mop containing moisture in order to effectively remove foreign substances strongly attached to the floor surface. The wet robot cleaner has a water container and is configured such that water accommodated in the water container is supplied to the mop and the mop containing moisture wipes the floor surface to effectively remove the foreign substances strongly attached to the floor surface.

The mop of the wet robot cleaner has a circular shape and is configured to wipe the floor surface while rotating in a state of being in contact with the floor surface. In addition, the robot cleaner is sometimes configured to move in a particular direction using a frictional force generated when a plurality of mops rotates in a state of being in contact with the floor surface.

Meanwhile, as the frictional force between the mop and the floor surface increases, the mop may strongly wipe the floor surface, such that the robot cleaner may effectively clean the floor surface.

Meanwhile, U.S. Pat. No. 8,452,450 B2 discloses a robot cleaner that cleans a floor surface while moving on the floor surface.

The robot cleaner may move on the floor surface along a preset movement pattern. In this case, the robot cleaner may uniformly clean a cleaning zone while moving along a wall in the cleaning zone. That is, the robot cleaner continuously moves forward until the robot cleaner recognizes an obstacle, and when the obstacle is detected, the robot cleaner may change a direction thereof and then move.

However, in a case in which a partial region on the floor surface is severely contaminated, the severely contaminated region is not sufficiently cleaned even though the robot cleaner passes through the region once.

Meanwhile, Korean Patent No. KR 1412582 B1 discloses a robot cleaner that sets a predetermined cleaning region in a cleaning target space and cleans only the set region.

The robot cleaner may clean only the contaminated partial region in the cleaning target space.

However, even the robot cleaner just passes through the partial region once but does not concentratedly and repeatedly clean the contaminated region. Therefore, the severely contaminated partial region cannot be precisely cleaned.

Meanwhile, Japanese Patent Application Laid-Open No. JP 2008-0108201 A discloses a robot cleaner that reciprocates while turning around an obstacle, an edge, a wall, and the like.

The robot cleaner divides a cleaning region into a plurality of movement regions and moves in the respective movement regions, and the adjacent movement regions may overlap each other.

However, movement directions of the robot cleaner in the adjacent movement regions are perpendicular to each other, and as a result, the robot cleaner repeatedly cleans the cleaning region twice.

Therefore, the robot cleaner just cleans the entire cleaning region twice but cannot repeatedly clean the severely contaminated particular region. The robot cleaner rather unnecessarily cleans a less contaminated region twice, which causes a waste of energy and cleaning time.

Accordingly, there is a need to develop a robot cleaner capable of cleaning an entire cleaning region and repeatedly cleaning a particular region with a high degree of contamination.

### DISCLOSURE

### Technical Problem

The present disclosure has been made in an effort to solve the above-mentioned problems of the robot cleaner and the method of controlling the robot cleaner in the related art, and an object of the present disclosure is to provide a robot cleaner and a method of controlling the robot cleaner, which are configured to repeatedly clean a floor surface. Another object of the present disclosure is to provide a robot cleaner and a method of controlling the robot cleaner, which are capable of precisely cleaning a severely contaminated floor surface.

Still another object of the present disclosure is to provide a robot cleaner and a method of controlling the robot cleaner, which are capable of cleaning an entire cleaning region and repeatedly cleaning a particular region with a high degree of contamination.

Yet another object of the present disclosure is to provide a robot cleaner and a method of controlling the robot cleaner, which are configured to reduce the time required to move the robot cleaner and perform a cleaning operation.

### Technical Solution

In order to achieve the above-mentioned objects, the present disclosure provides a robot cleaner including: a main body having a bumper provided on a front surface thereof and having a space for accommodating a battery, a water container, and a motor therein; and a pair of rotary plates rotatably disposed on a bottom surface of the main body and having a lower side.

In this case, the main body may move in a predetermined first cleaning region on the floor surface and then move in a predetermined second cleaning region, and the second cleaning region may at least partially overlap the first cleaning region.

The main body may rotate at a position at which the first cleaning region and the second cleaning region overlap each other.

The first cleaning region may be divided based on a boundary of an obstacle or an imaginary line on the floor surface, and the main body may rotate by a predetermined direction change angle when it is detected that the main body has reached the boundary.

In order to achieve the above-mentioned objects, the present disclosure provides a method of controlling a robot cleaner including a pair of rotary plates having lower sides to which mops facing a floor surface are coupled, the robot cleaner being configured to move by rotating the pair of rotary plates, the method including: a region setting step of setting a cleaning region on the floor surface; and a movement step of moving the robot cleaner in the cleaning region.

The region setting step may divide the cleaning region into a plurality of divided regions, and the plurality of divided regions may at least partially overlap one another.

The region setting step may include: a cleaning region setting step of setting the cleaning region on the floor surface; and a divided region setting step of dividing the cleaning region into the plurality of divided regions.

The region setting step may set a boundary of the cleaning region by detecting an obstacle including a wall and applying a position of the obstacle.

The region setting step may set the imaginary divided region having a rectangular shape in the cleaning region.

The region setting step may set the divided region including an imaginary first starting line including a predetermined starting position and an imaginary first ending line provided in parallel with the first starting line and disposed at a predetermined distance interval from the first starting line.

The region setting step may set a first divided region including an imaginary first starting line including a predetermined starting position and an imaginary first ending line provided in parallel with the first starting line and disposed at a predetermined distance interval from the first starting line, and set a second divided region including a second starting line and an imaginary second ending line provided in parallel with the second starting line and disposed at a predetermined distance interval from the second starting line.

In this case, the second starting line may at least partially overlap the first ending line.

Alternately, the second starting line may be set in the first divided region.

The region setting step may set an imaginary first divided region and an imaginary second divided region in the cleaning region, the first divided region and the second divided region may at least partially overlap each other, and in the movement step, the robot cleaner may move in the first divided region and then move in the second divided region.

The movement step may include: a first region movement step of moving the robot cleaner in any one of the divided regions; and a second region movement step of moving the robot cleaner in another of the divided regions.

The movement step may include: a first forward movement step of moving the robot cleaner from a predetermined first starting line to a first ending line provided in parallel with the first starting line and disposed at a predetermined distance interval from the first starting line; a first direction change step of rotating the robot cleaner after the first forward movement step; a second forward movement step of moving the robot cleaner from the first ending line to the first starting line; and a second direction change step of rotating the robot cleaner after the second forward movement step.

The first direction change step may be performed when an obstacle is detected while the robot cleaner moves in the first forward movement step.

The first direction change step may rotate the robot cleaner by a predetermined direction change angle.

A rotation angle of the robot cleaner in the first direction change step may be equal to a rotation angle of the robot cleaner in the second direction change step, and a rotation direction of the robot cleaner in the first direction change step may be opposite to a rotation direction of the robot cleaner in the second direction change step.

The method may further include a first movement preparation step of disposing the robot cleaner at a starting point before the first region movement step.

The second region movement step may allow the robot cleaner to start to move in a region in which the divided regions overlap one another.

The second region movement step may allow the robot cleaner to start to move from a point at which the first region movement step is ended.

The first region movement step may allow the robot cleaner to start to move from a predetermined starting point and move to a first direction change point provided at a predetermined distance interval from the predetermined starting point and then repeat a rotation and a movement of the robot cleaner multiple times, and the second region movement step may allow the robot cleaner to start to move from the first direction change point.

### Advantageous Effect

According to the robot cleaner and the method of controlling the robot cleaner according to the present disclosure as described above, the cleaning region is divided into the plurality of divided regions, the plurality of divided regions at least partially overlaps one another, and the robot cleaner moves in the plurality of divided regions. As a result, it is possible to clean the entire region and repeatedly clean the particular region.

In addition, the severely contaminated portion may be set as the region having the divided regions overlapping one another, and the robot cleaner may precisely clean the severely contaminated floor surface while repeatedly moving on the severely contaminated floor surface.

In addition, it is possible to reduce the time required to clean the entire cleaning region and repeatedly clean the portion with a high degree of contamination.

### DESCRIPTION OF DRAWINGS

FIG. 1 is a perspective view illustrating a robot cleaner according to an embodiment of the present disclosure.

FIG. 2 is a view illustrating some components separated from the robot cleaner illustrated in FIG. 1.

FIG. 3 is a rear view illustrating the robot cleaner illustrated in FIG. 1.

FIG. 4 is a bottom plan view illustrating the robot cleaner according to the embodiment of the present disclosure.

FIG. 5 is an exploded perspective view illustrating the robot cleaner.

FIG. 6 is a cross-sectional view schematically illustrating the robot cleaner and components of the robot cleaner according to the embodiment of the present disclosure.

FIG. 7 is a view for explaining a movement direction of the robot cleaner according to the embodiment of the present disclosure.

FIG. 8 is a schematic view illustrating the robot cleaner according to the embodiment of the present disclosure when viewed from above.

FIG. 9 is a block diagram of the robot cleaner according to the embodiment of the present disclosure.

FIG. 10 is a flowchart illustrating a method of controlling the robot cleaner according to the embodiment of the present disclosure.

FIG. 11 is a flowchart for explaining a first region movement step of the method of controlling the robot cleaner according to the embodiment of the present disclosure.

FIG. 12 is a schematic view for explaining a region setting step of the method of controlling the robot cleaner according to the embodiment of the present disclosure.

FIGS. 13A to 13F are schematic views for explaining the first region movement step of the method of controlling the robot cleaner according to the embodiment of the present disclosure.

FIGS. 14A to 14D are schematic views for explaining a second region movement step of the method of controlling the robot cleaner according to the embodiment of the present disclosure.

FIG. 15 is a schematic view for explaining an example in which the robot cleaner moves forward while forming a curve in accordance with the method of controlling the robot cleaner according to the embodiment of the present disclosure.

FIG. 16 is a schematic view for explaining a first region movement step of a method of controlling the robot cleaner according to another embodiment of the present disclosure.

FIGS. 17A and 17B are schematic views for explaining states in which the robot cleaner moves toward a starting point to start a second region movement step of a method of controlling the robot cleaner according to still another embodiment of the present disclosure.

### MODE FOR INVENTION

Hereinafter, exemplary embodiments of the present disclosure will be described in detail with reference to the accompanying drawings.

The present disclosure may be variously modified and may have various embodiments, and particular embodiments illustrated in the drawings will be specifically described below. The description of the embodiments is not intended to limit the present disclosure to the particular embodiments, but it should be interpreted that the present disclosure is to cover all modifications, equivalents and alternatives falling within the spirit and technical scope of the present disclosure.

The terms used herein is used for the purpose of describing particular embodiments only and is not intended to limit the present disclosure. Singular expressions may include plural expressions unless clearly described as different meanings in the context.

Unless otherwise defined, all terms used herein, including technical or scientific terms, may have the same meaning as commonly understood by those skilled in the art to which the present disclosure pertains. The terms such as those defined in a commonly used dictionary may be interpreted as having meanings consistent with meanings in the context of related technologies and may not be interpreted as ideal or excessively formal meanings unless explicitly defined in the present application.

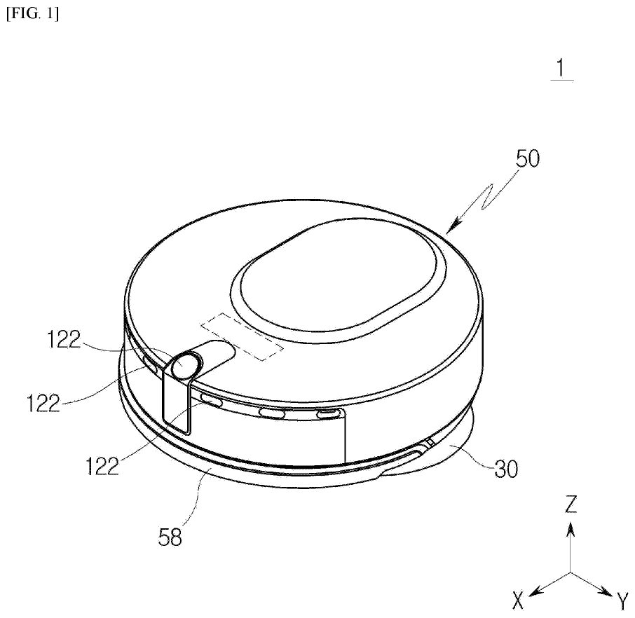

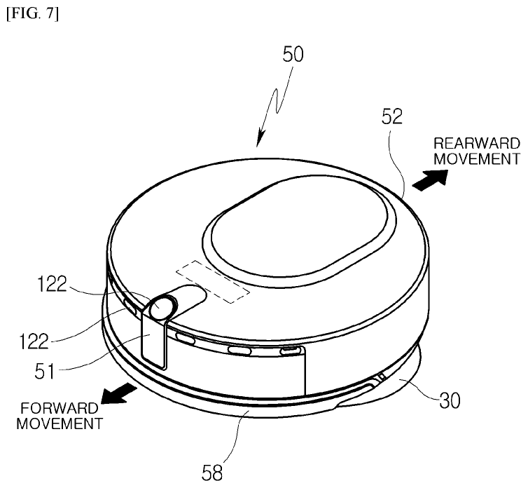

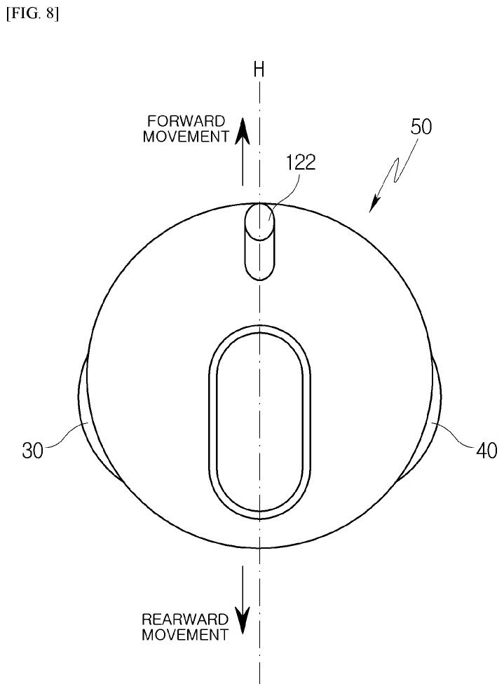

FIGS. 1 to 6 are structural views for explaining a structure of a robot cleaner according to an embodiment of the present disclosure, and FIGS. 7 and 8 are views for explaining movement directions of the robot cleaner according to the embodiment of the present disclosure.

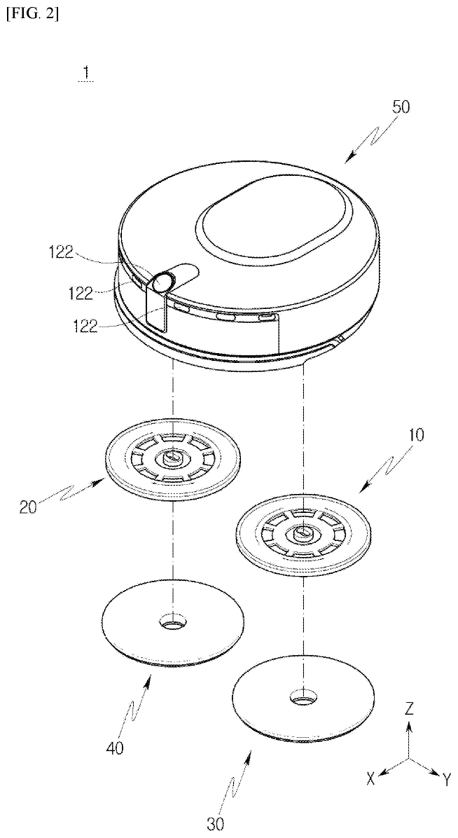

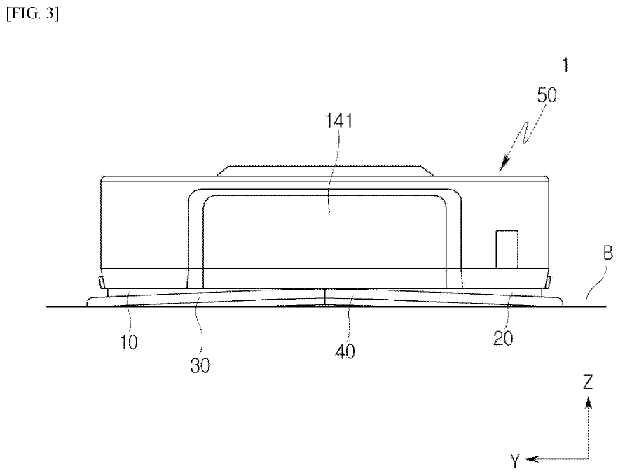

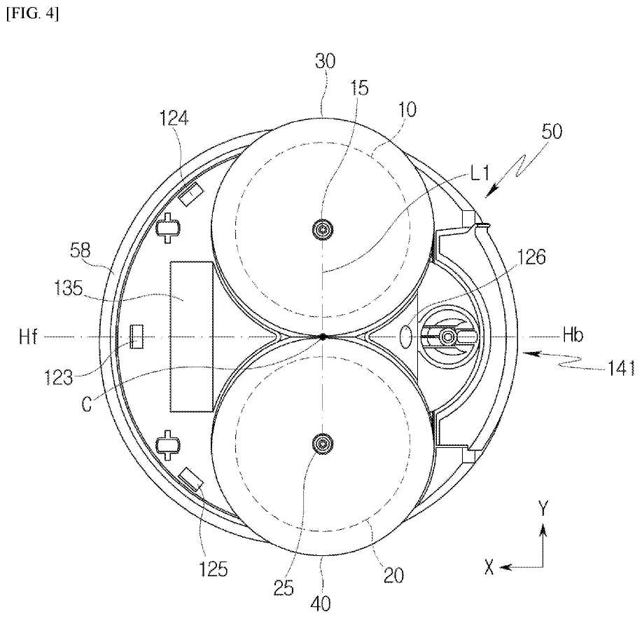

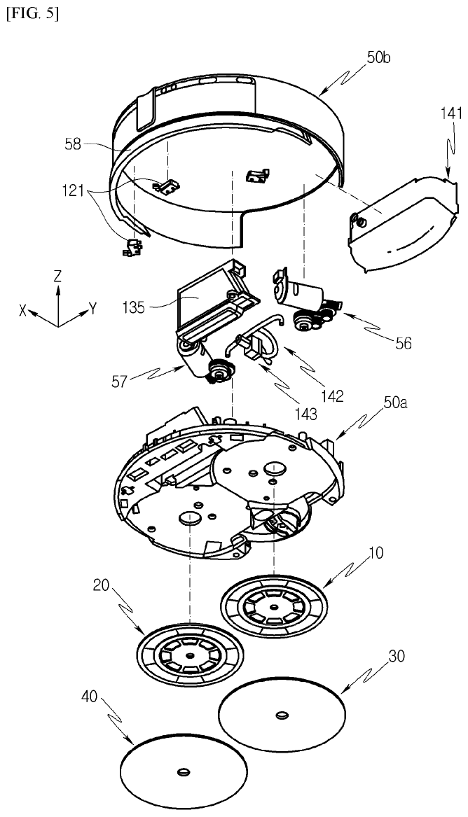

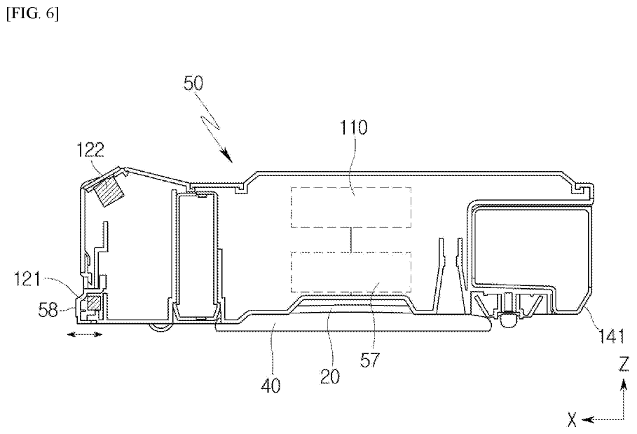

More specifically, FIG. 1 is a perspective view illustrating a robot cleaner 1, FIG. 2 is a view illustrating some components separated from the robot cleaner 1, FIG. 3 is a rear view of the robot cleaner 1, FIG. 4 is a bottom plan view of the robot cleaner 1, FIG. 5 is an exploded perspective view of the robot cleaner 1, and FIG. 6 is a cross-sectional view illustrating an interior of the robot cleaner 1.

A structure of the robot cleaner 1 according to the present disclosure will be described below with reference to FIGS. 1 to 8.

The robot cleaner 1 is configured to be placed on a floor and clean the floor using mops while moving on a floor surface B. Therefore, hereinafter, a vertical direction is defined based on a state in which the robot cleaner 1 is placed on the floor.

Further, a side at which a first lower sensor 123 to be described below is defined as a front side based on a first rotary plate 10 and a second rotary plate 20.

Among the portions described in the present disclosure, a ‘lowermost portion’ may be a portion positioned at a lowest position or a portion closest to the floor when the robot cleaner 1 is placed on the floor and used.

The robot cleaner 1 may include a main body 50, rotary plates 10 and 20, and mops 30 and 40. In this case, the rotary plates 10 and 20 may be provided in a pair and include a first rotary plate 10 and a second rotary plate 20, and the mops 30 and 40 may include a first mop 30 and a second mop 40.

The main body 50 may define an entire external shape of the robot cleaner 1 or may be provided in the form of a frame. Components constituting the robot cleaner 1 may be coupled to the main body 50, and some of the components constituting the robot cleaner 1 may be accommodated in the main body 50. The main body 50 may be divided into a lower main body 50a and an upper main body 50b. The components of the robot cleaner 1 including a battery 135, a water container 141, and motors 56 and 57 are provided in a space defined by coupling the lower main body 50a and the upper main body 50b (see FIG. 5).

The first rotary plate 10 may be rotatably disposed on a bottom surface of the main body 50, and the first mop 30 may be coupled to a lower side of the first rotary plate 10.

The first rotary plate 10 has a predetermined area and is provided in the form of a flat plate, a flat frame, or the like. The first rotary plate 10 is laid approximately horizontally, such that a width (or a diameter) in the horizontal direction is sufficiently larger than a height in the vertical direction thereof. The first rotary plate 10 coupled to the main body 50 may be parallel to the floor surface B or inclined with respect to the floor surface B. The first rotary plate 10 may be provided in the form of a circular plate, a bottom surface of the first rotary plate 10 may be approximately circular, and the first rotary plate 10 may entirely have a rotationally symmetrical shape.

The second rotary plate 20 may be rotatably disposed on the bottom surface of the main body 50, and the second mop 40 may be coupled to a lower side of the second rotary plate 20.

The second rotary plate 20 has a predetermined area and is provided in the form of a flat plate, a flat frame, or the like. The second rotary plate 20 is laid approximately horizontally, such that a width (or a diameter) in the horizontal direction thereof is sufficiently larger than a height in the vertical direction thereof. The second rotary plate 20 coupled to the main body 50 may be parallel to the floor surface B or inclined with respect to the floor surface B. The second rotary plate 20 may be provided in the form of a circular plate shape, a bottom surface of the second rotary plate 20 may be approximately circular, and the second rotary plate 20 may entirely have a rotationally symmetrical shape.

In the robot cleaner 1, the second rotary plate 20 may be identical to the first rotary plate 10 or the second rotary plate 20 and the first rotary plate 10 may be provided symmetrically. When the first rotary plate 10 is positioned at a left side of the robot cleaner 1, the second rotary plate 20 may be positioned at a right side of the robot cleaner 1. In this case, the first rotary plate 10 and the second rotary plate 20 may be vertically symmetric.

The first mop 30 may be coupled to the lower side of the first rotary plate 10 so as to face the floor surface B.

A bottom surface of the first mop 30, which is directed toward the floor, has a predetermined area, and the first mop 30 has a flat shape. The first mop 30 is configured such that a width (or a diameter) in the horizontal direction thereof is sufficiently larger than a height in the vertical direction thereof. When the first mop 30 is coupled to the main body 50, the bottom surface of the first mop 30 may be parallel to the floor surface B or inclined with respect to the floor surface B.

The bottom surface of the first mop 30 may be approximately circular, and the first mop 30 may entirely have a rotationally symmetrical shape. In addition, the first mop 30 may be attached to or detached from the bottom surface of the first rotary plate 10. The first mop 30 may be coupled to the first rotary plate 10 and rotate together with the first rotary plate 10.

The second mop 40 may be coupled to the lower side of the second rotary plate 20 so as to face the floor surface B.

A bottom surface of the second mop 40, which is directed toward the floor, has a predetermined area, and the second mop 40 has a flat shape. The second mop 40 is configured such that a width (or a diameter) in the horizontal direction thereof is sufficiently larger than a height in the vertical direction thereof. When the second mop 40 is coupled to the main body 50, the bottom surface of the second mop 40 may be parallel to the floor surface B or inclined with respect to the floor surface B.

The bottom surface of the second mop 40 may be approximately circular, and the second mop 40 may entirely have a rotationally symmetrical shape. In addition, the second mop 40 may be attached to or detached from the bottom surface of the second rotary plate 20. The second mop 40 may be coupled to the second rotary plate 20 and rotate together with the second rotary plate 20.

When the first rotary plate 10 and the second rotary plate 20 rotate in opposite directions at the same velocity, the robot cleaner 1 may move forward or rearward in a straight direction. For example, when the first rotary plate 10 rotates counterclockwise and the second rotary plate 20 rotates clockwise when viewed from above, the robot cleaner 1 may move forward.

When only any one of the first rotary plate 10 and the second rotary plate 20 rotates, the robot cleaner 1 may change the direction thereof and turn. When a rotational velocity of the first rotary plate 10 and a rotational velocity of the second rotary plate 20 are different from each other or the first rotary plate 10 and the second rotary plate 20 rotate in the same direction, the robot cleaner 1 may move while changing the direction thereof and move in a curved direction.

The robot cleaner 1 may further include the first lower sensor 123.

The first lower sensor 123 is provided at the lower side of the main body 50 and configured to detect a relative distance to the floor B. The first lower sensor 123 may be variously configured as long as the first lower sensor 123 may detect the relative distance between the floor surface B and the point at which the first lower sensor 123 is provided.

When the relative distance to the floor surface B (a distance in the vertical direction from the floor surface or a distance in the direction inclined with respect to the floor surface), which is detected by the first lower sensor 123, exceeds a predetermined value or exceeds a predetermined range, this may be a case in which the floor surface is rapidly lowered. Therefore, the first lower sensor 123 may detect a cliff

The first lower sensor 123 may be an optical sensor and include a light-emitting portion for emitting light, and a light-receiving portion for receiving reflected light. The first lower sensor 123 may be an infrared sensor.

The first lower sensor 123 may be referred to as a cliff sensor.

The robot cleaner 1 may further include a second lower sensor 124 and a third lower sensor 125.

When an imaginary line, which connects a center of the first rotary plate 10 and a center of the second rotary plate 20 in the horizontal direction (the direction parallel to the floor surface B), is a connection line L1, the second lower sensor 124 and the third lower sensor 125 may be provided at the lower side of the main body 50 and disposed at the same side as the first lower sensor 123 based on the connection line L1. The second lower sensor 124 and the third lower sensor 125 may be configured to detect the relative distance to the floor B (see FIG. 4).

The third lower sensor 125 may be provided at a side opposite to the second lower sensor 124 based on the first lower sensor 123.

Each of the second lower sensor 124 and the third lower sensor 125 may be variously configured as long as each of the second lower sensor 124 and the third lower sensor 125 may detect the relative distance to the floor surface B. Each of the second lower sensor 124 and the third lower sensor 125 may be identical to the first lower sensor 123 except for the positions at which the sensors are provided. The robot cleaner 1 may further include the first motor 56, the second motor 57, the battery 135, the water container 141, and a water supply tube 142.

The first motor 56 may be coupled to the main body 50 and configured to rotate the first rotary plate 10. Specifically, the first motor 56 may be an electric motor coupled to the main body 50, and one or more gears may be connected to the first motor 56 to transmit a rotational force to the first rotary plate 10.

The second motor 57 may be coupled to the main body 50 and configured to rotate the second rotary plate 20. Specifically, the second motor 57 may be an electric motor coupled to the main body 50, and one or more gears may be connected to the second motor 57 to transmit a rotational force to the second rotary plate 20.

As described above, in the robot cleaner 1, the first rotary plate 10 and the first mop 30 may be rotated by the operation of the first motor 56, and the second rotary plate 20 and the second mop 40 may be rotated by the operation of the second motor 57.

The second motor 57 and the first motor 56 may be symmetric (vertically symmetric).

The battery 135 may be coupled to the main body 50 and configured to supply power the other components constituting the robot cleaner 1. The battery 135 may supply power to the first motor 56 and the second motor 57.

The battery 135 may be charged with external power. To this end, a charging terminal for charging the battery 135 may be provided at one side of the main body 50 or provided on the battery 135.

In the robot cleaner 1, the battery 135 may be coupled to the main body 50.

The water container 141 is provided in the form of a container having an internal space that stores therein a liquid such as water. The water container 141 may be fixedly coupled to the main body 50 or detachably coupled to the main body 50.

In the robot cleaner 1, the water supply tube 142 is provided in the form of a tube or a pipe and connected to the water container 141 so that the liquid in the water container 141 may flow through the inside of the water supply tube 142. An end of the water supply tube 142, which is opposite to the side at which the water supply tube 142 is connected to the water container 141, is provided above the first rotary plate 10 and the second rotary plate 20, such that the liquid in the water container 141 may be supplied to the first mop 30 and the second mop 40.

In the robot cleaner 1, the water supply tube 142 may be provided in a shape having two tube portions diverged from a single tube portion. In this case, an end of one diverged tube portion may be positioned above the first rotary plate 10, and an end of the other diverged tube portion may be positioned above the second rotary plate 20.

The robot cleaner 1 may have a separate water pump 143 to move the liquid through the water supply tube 142.

The robot cleaner 1 may further include a bumper 58, a first sensor 121, and a second sensor 122.

The bumper 58 is coupled along a rim of the main body 50 and configured to move relative to the main body 50. For example, the bumper 58 may be coupled to the main body 50 so as to be reciprocally movable in a direction toward the center of the main body 50.

The bumper 58 may be coupled along a part of the rim of the main body 50 or coupled along the entire rim of the main body 50.

The first sensor 121 may be coupled to the main body 50 and configured to detect a motion (relative movement) of the bumper 58 relative to the main body 50. The first sensor 121 may be a microswitch, a photo-interrupter, a tact switch, or the like.

The second sensor 122 may be coupled to the main body 50 and configured to detect the relative distance to an obstacle. The second sensor 122 may be a distance sensor.

Meanwhile, the robot cleaner 1 according to the embodiment of the present disclosure may further include a displacement sensor 126.

The displacement sensor 126 may be disposed on the bottom surface (rear surface) of the main body 50 and measure a distance by which the robot cleaner moves along the floor surface.

For example, an optical flow sensor (OFS) for acquiring image information on the floor surface using light may be used as the displacement sensor 126. In this case, the optical flow sensor (OFS) includes an image sensor configured to acquire image information on the floor surface by capturing an image of the floor surface, and one or more light sources configured to adjust the amount of light.

An operation of the displacement sensor 126 will be described as an example of the optical flow sensor. The optical flow sensor is provided on the bottom surface (rear surface) of the robot cleaner 1 and captures an image of a lower portion, that is, the floor surface while the robot cleaner 1 moves. The optical flow sensor converts a lower image inputted from the image sensor and creates a predetermined lower image information.

With this configuration, the displacement sensor 126 may detect a position of the robot cleaner 1 relative to a predetermined point regardless of slippage. That is, the optical flow sensor may be used to observe the lower portion of the robot cleaner 1, such that it is possible to correct a position caused by slippage.

Meanwhile, the robot cleaner 1 according to the embodiment of the present disclosure may further include an angle sensor 127.

The angle sensor 127 may be disposed in the main body 50 and measure a movement angle of the main body 50.

For example, a gyro sensor for measuring a rotational velocity of the main body 50 may be used as the angle sensor 127. The gyro sensor may detect the direction of the robot cleaner 1 using the rotational velocity.

With this configuration, based on a predetermined imaginary line, the angle sensor 127 may detect a direction in which the robot cleaner 1 moves and an angle at which the robot cleaner 1 moves.

Meanwhile, the present disclosure may further include the imaginary connection line L1 that connects rotation axes of the pair of rotary plates 10 and 20. Specifically, the connection line L1 may mean an imaginary line that connects the rotation axis of the first rotary plate 10 and the rotation axis of the second rotary plate 20. The connection line L1 may be a criterion based on which the front and rear sides of the robot cleaner 1 are defined. For example, a side at which the first lower sensor 123 is disposed based on the connection line L1 may be referred to as the front side of the robot cleaner 1, and a side at which the water container 141 is disposed based on the connection line L1 may be referred to as the rear side of the robot cleaner 1.

Therefore, based on the connection line L1, the first lower sensor 123, the second lower sensor 124, and the third lower sensor 125 may be disposed at a front lower side of the main body 50, the first sensor 121 may be disposed inside a front outer circumferential surface of the main body 50, and the second sensor 122 may be disposed at a front upper side of the main body 50. In addition, based on the connection line L1, the battery 135 may be inserted and coupled into a front side of the main body 50 in a direction perpendicular to the floor surface B. Further, based on the connection line L1, the displacement sensor 126 may be disposed at a rear side of the main body 50.

Therefore, based on the connection line L1, a surface of the main body 50 on which the first sensor 121 and the bumper 58 are positioned may be referred to as a front surface of the main body 50, and a surface of the main body 50, which is opposite to the front surface, may be referred to as a rear surface of the main body 50.

Meanwhile, the present disclosure may further include an imaginary movement direction line H that extends in parallel with the floor surface B and perpendicularly intersects the connection line L1 at an intermediate point C of the connection line L1. Specifically, the movement direction line H may include a forward movement direction line Hf extending in parallel with the floor surface B toward the side at which the battery 135 is disposed based on the connection line L1, and a rearward movement direction line Hb extending in parallel with the floor surface B toward the side at which the water container 141 is disposed based on the connection line L1. Therefore, the battery 135 and the first lower sensor 123 may be disposed in the forward movement direction line Hf, and the displacement sensor 126 and the water container 141 may be disposed in the rearward movement direction line Hb. Further, based on the movement direction line H, the first rotary plate 10 and the second rotary plate 20 may be disposed symmetrically (linearly symmetrically).

With this configuration, the movement direction line H may mean the direction in which the robot cleaner 1 moves.

That is, a state in which the robot cleaner 1 moves along the forward movement direction line Hf may be referred to as a forward movement, and a state in which the robot cleaner 1 moves along the rearward movement direction line Hb may be referred to as a rearward movement.

Meanwhile, in order to assist in understanding the present disclosure, a front end of the robot cleaner 1 according to the present disclosure will be described below. The front end of the robot cleaner 1 according to the present disclosure may mean a point farthest in distance forward from the connection line L1 in the horizontal direction. For example, the front end of the robot cleaner 1 may mean a point on an outer circumferential surface of the bumper 58 through which the forward movement direction line Hf passes.

In addition, a rear end of the robot cleaner 1 may mean a point farthest in distance rearward from the connection line L1 in the horizontal direction. For example, the rear end of the robot cleaner 1 may mean a point on an outer surface of the water container 141 through which the rearward movement direction line Hb passes.

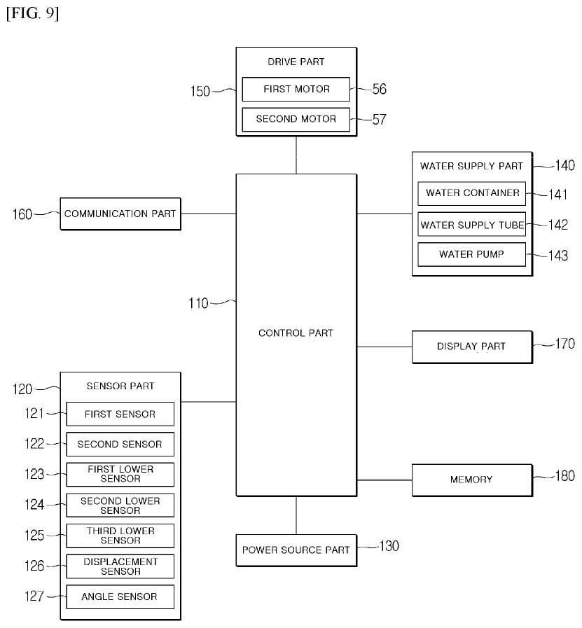

Meanwhile, FIG. 9 is a block diagram of the robot cleaner according to the present disclosure illustrated in FIG. 1.

Referring to FIG. 9, the robot cleaner 1 may include a control part 110, a sensor part 120, a power source part 130, a water supply part 140, a drive part 150, a communication part 160, a display part 170, and a memory 180. The constituent elements illustrated in the block diagram of FIG. 2 are not essential to implement the robot cleaner 1. The robot cleaner 1 described in the present specification may have the constituent elements larger or smaller in number than the constituent elements listed above.

First, the control part 110 may be disposed in the main body 50 and connected to a control device (not illustrated) in a wireless communication manner through the communication part 160 to be described below. In this case, the control part 110 may transmit various data in relation to the robot cleaner 1 to the connected control device (not illustrated). Further, the control part 110 may receive inputted data from the control device and store the data. In this case, the data inputted from the control device may be a control signal for controlling at least one function of the robot cleaner 1.

In other words, the robot cleaner 1 may receive the control signal made based on a user's input from the control device and operate based on the received control signal.

In addition, the control part 110 may control an overall operation of the robot cleaner. The control part 110 controls the robot cleaner 1 so that the robot cleaner 1 performs the cleaning operation while autonomously moving on a cleaning target surface based on set information stored in the memory 180 to be described below.

Meanwhile, in the present disclosure, a process of controlling a straight movement by the control part 110 will be described below.

The sensor part 120 may include one or more of the first lower sensor 123, the second lower sensor 124, the third lower sensor 125, the first sensor 121, and the second sensor 122 of the robot cleaner 1 which are described above.

In other words, the sensor part 120 may include a plurality of different sensors capable of detecting the environment at the periphery of the robot cleaner 1. Information on the environment at the periphery of the robot cleaner 1 detected by the sensor part 120 may be transmitted to the control device by the control part 110. In this case, the information on the peripheral environment may be whether an obstacle is present, whether a cliff is detected, whether a collision is detected, or the like, for example.

The control part 110 may control the operations of the first motor 56 and/or the second motor 57 based on the information detected by the first sensor 121. For example, when the bumper 58 comes into contact with an obstacle while the robot cleaner 1 moves, the first sensor 121 may recognize a position at which the bumper 58 comes into contact with the obstacle, and the control part 110 may control the operations of the first motor 56 and/or the second motor 57 so that the robot cleaner 1 departs from the contact position.

In addition, when a distance between the robot cleaner 1 and the obstacle is a predetermined value or less based on the information detected by the second sensor 122, the control part 110 may control the operations of the first motor 56 and/or the second motor 57 so that the movement direction of the robot cleaner 1 is changed or the robot cleaner 1 moves away from the obstacle.

In addition, based on a distance detected by the first lower sensor 123, the second lower sensor 124, or the third lower sensor 125, the control part 110 may control the operations of the first motor 56 and/or the second motor 57 so that the robot cleaner 1 is stopped or the movement direction is changed.

In addition, based on a distance detected by the displacement sensor 126, the control part 110 may control the operations of the first motor 56 and/or the second motor 57 so that the movement direction of the robot cleaner 1 is changed. For example, when the robot cleaner 1 slips and deviates from the inputted movement route or movement pattern, the displacement sensor 126 may measure a distance by which the robot cleaner 1 deviates from the inputted movement route or movement pattern, and the control part 110 may control the operations of the first motor 56 and/or the second motor 57 to compensate for the deviation.

In addition, based on an angle detected by the angle sensor 127, the control part 110 may control the operations of the first motor 56 and/or the second motor 57 so that the movement direction of the robot cleaner 1 is changed. For example, when the robot cleaner 1 slips and a direction toward the robot cleaner 1 deviates from an inputted movement direction, the angle sensor 127 may measure an angle by which the direction toward the robot cleaner 1 deviates from the inputted movement direction, and the control part 110 may control the operations of the first motor 56 and/or the second motor 57 to compensate for the deviation.

Meanwhile, under control of the control part 110, the power source part 130 receives power from an external power source or an internal power source and supplies the power required to operate the respective constituent elements. The power source part 130 may include the above-mentioned battery 135 of the robot cleaner 1.

The water supply part 140 may include the water container 141, the water supply tube 142, and the water pump 143 of the robot cleaner 1 which are described above. The water supply part 140 may be configured to adjust a feed rate of the liquid (water) to be supplied to the first mop 30 and the second mop 40 during the cleaning operation of the robot cleaner 1 based on the control signal of the control part 110. The control part 110 may control an operating time of a motor that operates the water pump 143 to adjust the feed rate.

The drive part 150 may include the first motor 56 and the second motor 57 of the robot cleaner 1 which are described above. The drive part 150 may be configured to allow the robot cleaner 1 to rotate or rectilinearly move based on the control signal of the control part 110.

Meanwhile, the communication part 160 may be disposed in the main body 50 and may include at least one module that enables wireless communication between the robot cleaner 1 and a wireless communication system, between the robot cleaner 1 and a preset peripheral device, or between the robot cleaner 1 and a preset external server.

For example, the module may include at least one of an IR (infrared) module for infrared communication, an ultrasonic module for ultrasonic communication, and a short distance communication module such as a WiFi module or a Bluetooth module. Alternatively, the module may include a wireless Internet module to transmit and receive data to/from the preset devices through various wireless technologies such as WLAN (wireless LAN) or Wi-Fi (wireless fidelity).

Meanwhile, the display part 170 displays information to be provided to the user. For example, the display part 170 may include a display for displaying a screen. In this case, the display may be exposed from an upper surface of the main body 50.

In addition, the display part 170 may include a speaker configured to output sound. For example, the speaker may be embedded in the main body 50. In this case, the main body 50 may have a hole that is formed to correspond to a position of the speaker allows sound to pass therethrough. A source of the sound outputted by the speaker may be sound data pre-stored in the robot cleaner 1. For example, the pre-stored sound data may be related to audio guidance corresponding to the respective functions of the robot cleaner 1 or alarm sound indicating errors.

In addition, the display part 170 may include any one of a light-emitting diode (LED), a liquid crystal display (LCD), a plasma display panel, and an organic light-emitting diode (OLED).

The memory 180 may include various data for driving and operating the robot cleaner. The memory 180 may include application programs and various related data for allowing the robot cleaner 1 to autonomously move. In addition, the memory 180 may store respective data detected by the sensor part 120 and include set information about various set values (e.g., reserved cleaning time, cleaning modes, feed rates, LED brightness, volume sizes of notification sound, and the like) selected or inputted by the user.

Meanwhile, the memory 180 may include information about a cleaning target surface given to the current robot cleaner 1. For example, the information about the cleaning target surface may be map information autonomously mapped by the robot cleaner 1. Further, the map information, that is, the map may include various information set by the user in respect to the respective regions constituting the cleaning target surface.

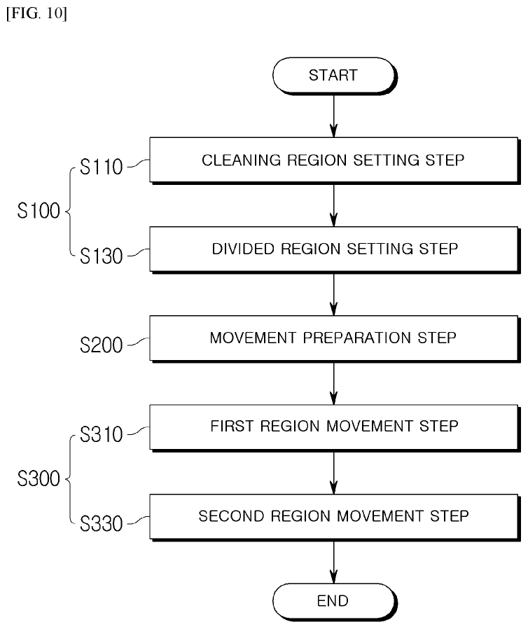

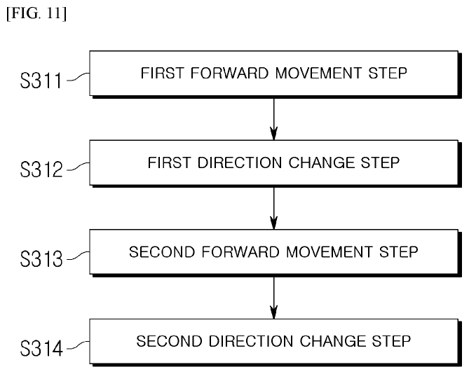

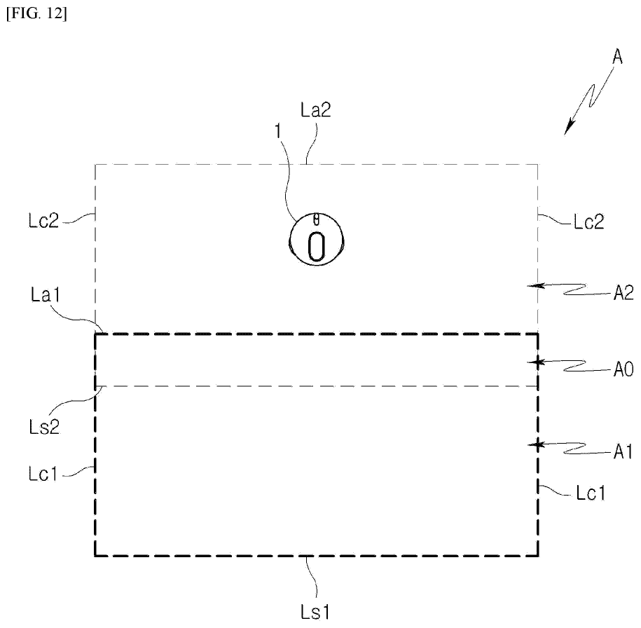

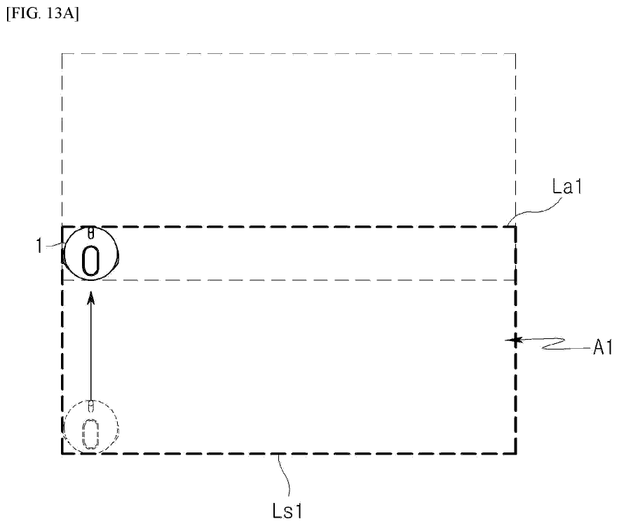

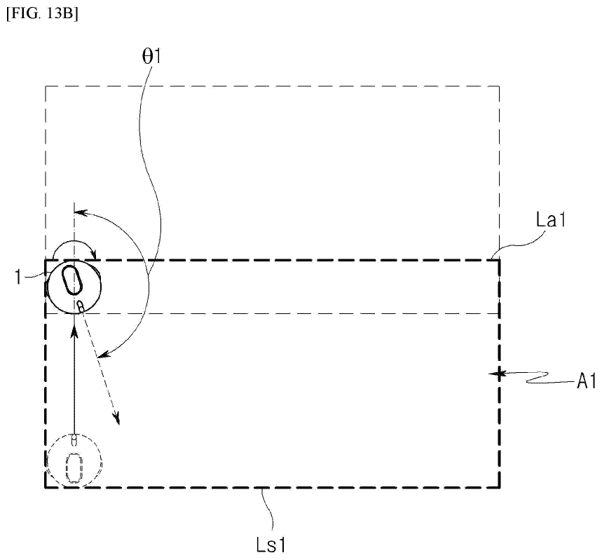

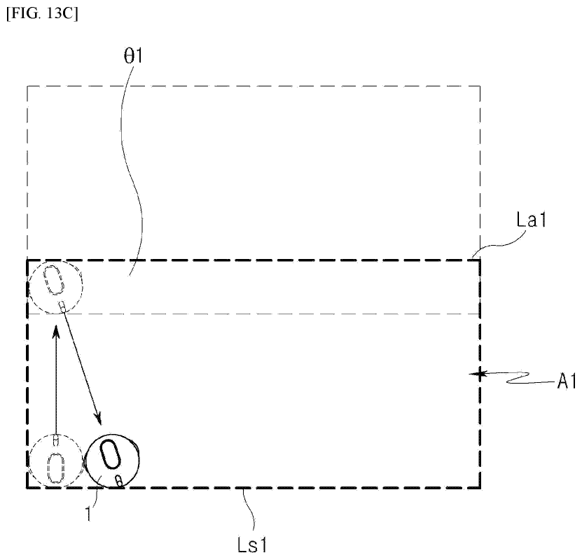

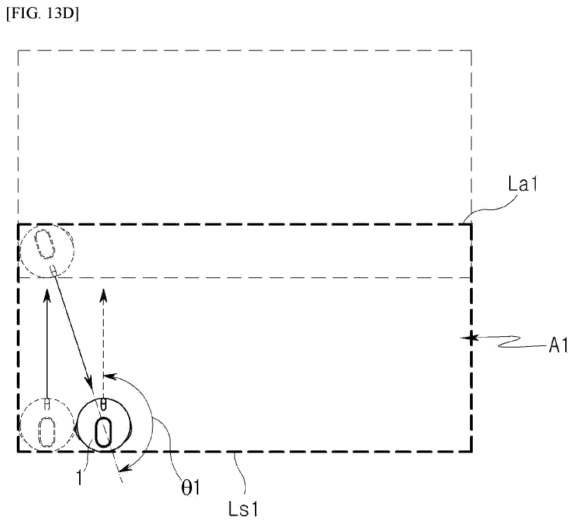

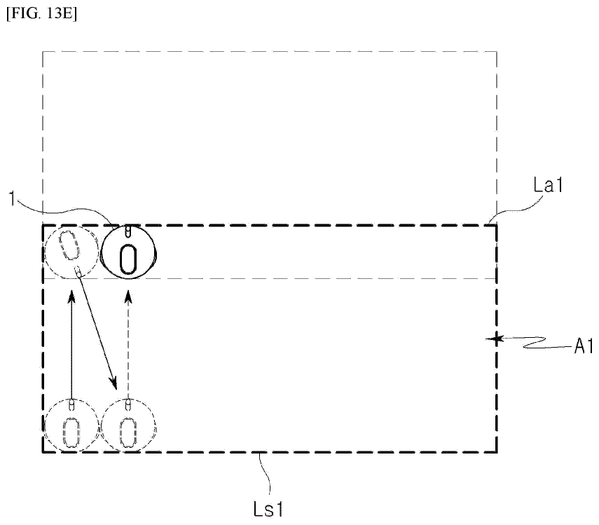

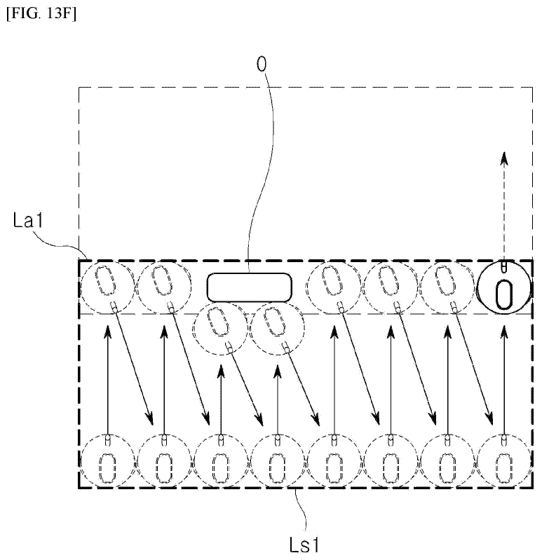

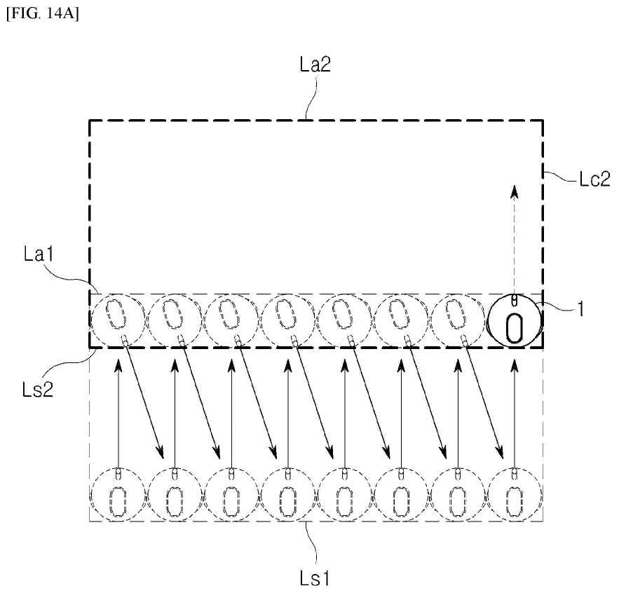

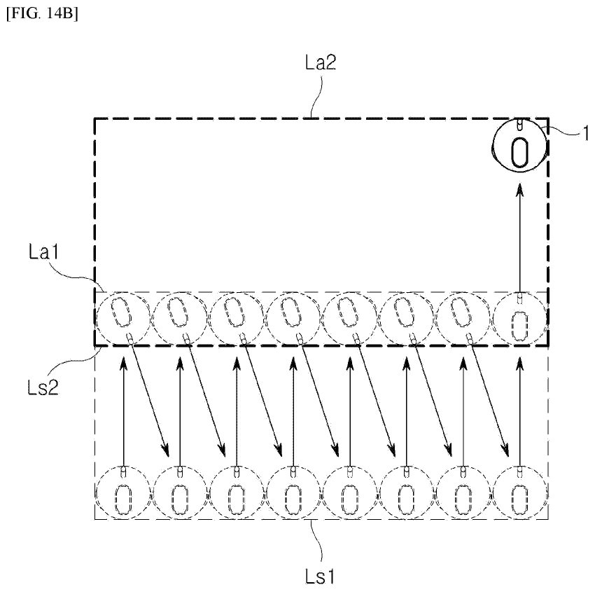

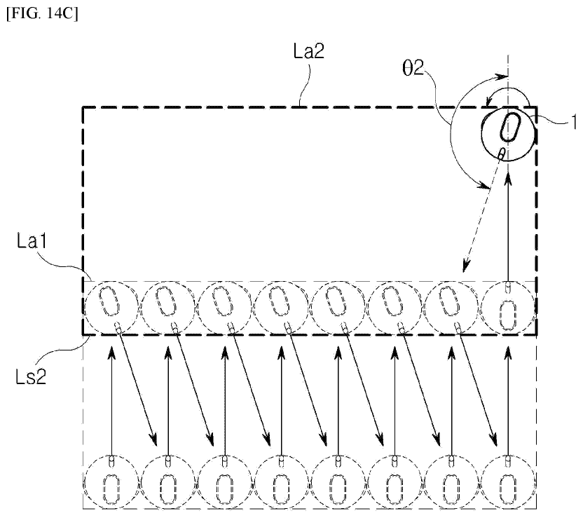

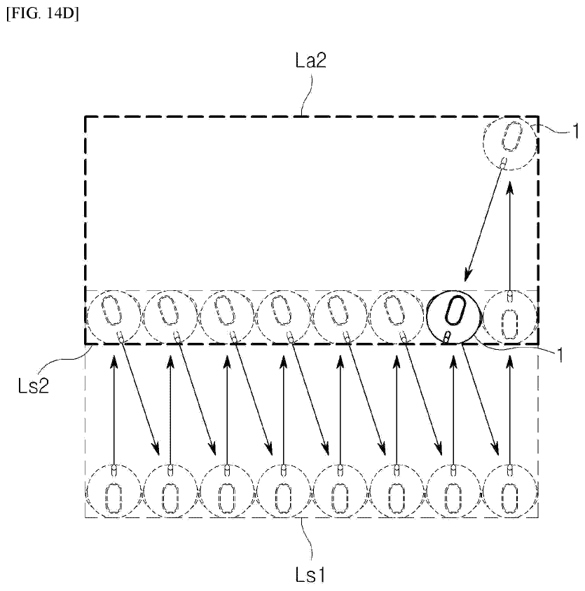

Meanwhile, FIG. 10 is a flowchart illustrating a method of controlling the robot cleaner according to the embodiment of the present disclosure, FIG. 11 is a flowchart for explaining a first region movement step of the method of controlling the robot cleaner according to the embodiment of the present disclosure, FIG. 12 is a schematic view for explaining a region setting step of the method of controlling the robot cleaner according to the embodiment of the present disclosure, FIGS. 13A to 13F are schematic views for explaining the first region movement step of the method of controlling the robot cleaner according to the embodiment of the present disclosure, and FIG. 14A to 14D are schematic views for explaining the second region movement step of the method of controlling the robot cleaner according to the embodiment of the present disclosure.

A method of controlling the robot cleaner according to the embodiment of the present disclosure will be described below with reference to FIGS. 1 to 14.

According to the present disclosure, the robot cleaner 1 may include information about the floor surface (the cleaning target surface). That is, the memory 180 of the robot cleaner 1 may store a map related to the cleaning region. For example, the information about the cleaning target surface may be map information autonomously mapped by the robot cleaner 1.

In contrast, the robot cleaner may create a map while moving in the cleaning region through Wall Following or the like in a case in which the map related to the floor surface is not stored in the robot cleaner 1 or in a case in which the robot cleaner initially operates. In addition, in a state in which there is no map, the robot cleaner 1 may create a map based on obstacle information acquired while the robot cleaner 1 cleans the floor surface B.

In addition, the sensor part 120 may detect an obstacle including a wall surface or the like while the robot cleaner 1 moves or before the robot cleaner 1 starts to move.

The robot cleaner 1 may create a map of the floor surface B based on the information about the obstacle.

Meanwhile, various well-known methods may be applied as a method of creating a map for the robot cleaner 1, and a detailed description thereof will be omitted. The method of controlling the robot cleaner according to the embodiment of the present disclosure includes a region setting step S100, a movement preparation step S200, a movement step S300, and a movement ending step S400.

The region setting step S100 includes a cleaning region setting step S110 and a divided region setting step S130.

The cleaning region setting step S110 may set a cleaning region A on the floor surface B.

For example, in the cleaning region setting step S110, the user may set the cleaning region A by inputting a coordinate of a particular position or a particular structure through a terminal (not illustrated) or the like.

Alternatively, in the cleaning region setting step S110, the sensor part 120 may detect an obstacle o including a wall, furniture, a structure, and the like, and the control part 110 may set the cleaning region A by applying a position of the obstacle o.

Therefore, the cleaning region setting step S110 may set a boundary B of the cleaning region A based on the user's input or the detection of the obstacle o by the control part 110.

The divided region setting step S130 may divide the cleaning region A set in the cleaning region setting step S110 into a plurality of divided regions A1, A2, . . . , and An.

In the divided region setting step S130, the control part 110 may set the imaginary divided regions A1, A2, . . . , and An each having a rectangular shape in the cleaning region

Specifically, in the divided region setting step S130, the control part 110 may set a first divided region A1 surrounded by a first starting line Ls1, a first ending line La1, and a pair of first connection lines Lc1 (S131).

In this case, the first starting line Ls1 may be an imaginary line indicating a predetermined starting position Ps in the cleaning region A. In addition, the first ending line La1 may be an imaginary line provided at a predetermined distance interval from the first starting line Ls1 and disposed in parallel with the first starting line Ls1. That is, the first starting line Ls1 and the first ending line La1 may be set side by side with a predetermined first distance D1 therebetween in a first direction.

In this case, the first direction may be a direction in which the robot cleaner 1 moves forward in a first forward movement step S311 to be described below.

Further, the first connection lines Lc1 may be imaginary lines that connect the first starting line Ls1 and the first ending line La1. For example, the pair of first connection lines Lc1 may be set side by side with a predetermined second distance D2 in a second direction. In this case, the second direction may be a direction perpendicular to the first direction.

Therefore, the first divided region A1 may be a region disposed on the floor surface and having a length in the first direction corresponding to the predetermined first distance D1 and a width in the second direction corresponding to the predetermined second distance D2.

Meanwhile, as another example, the first connection line Lc1 may be set based on the detected obstacle such as a wall surface. That is, the sensor part 120 may detect the obstacle such as a wall surface, and the control part 110 may set the imaginary first connection line Lc1 at the position of the obstacle, such that the first connection line Lc1 may be set.

Further, in the divided region setting step S130, the control part 110 may set a second divided region A2 that at least partially overlaps the first divided region A1 (S132).

The control part 110 may set the second divided region A2 surrounded by a second starting line Ls2, a second ending line La2, and a pair of second connection lines Lc2.

In this case, the second starting line Ls2 may be set in the first divided region A1. For example, the second starting line Ls2 may be set to be closer to the first starting line Ls1 than the first ending line La1. Therefore, the first divided region A1 and the second divided region A2 may overlap each other in a region between the first ending line La1 and the second starting line Ls2.

As another example, the second starting line Ls2 may be set to overlap the first ending line La1 and the same position. In this case, the robot cleaner 1 rotates on the first ending line La1 in a first movement step S310 to be described below, and the robot cleaner 1 rotates on the second starting line Ls2 in a second movement step S330 to be described below, such that the regions on the floor surface B to be cleaned by the robot cleaner 1 may overlap each other.

Meanwhile, in the divided region setting step S130, the control part 110 may detect a degree of contamination of the floor surface B and set a specific position with a high degree of contamination as the region in which the first divided region A1 and the second divided region A2 overlap each other. That is, in the divided region setting step

S130, the control part 110 may set the first ending line La1 and the second starting line Ls2 so that the specific position with a high degree of contamination is disposed between the first ending line La1 and the second starting line Ls2. Alternatively, the control part 110 may set the first ending line La1 and the second starting line Ls2 so that the specific position with a high degree of contamination is disposed on the same line of the first ending line La1 and the second starting line Ls2.

With the above-mentioned configuration, the robot cleaner 1 according to the present disclosure may precisely clean a severely contaminated area on the floor surface B while repeatedly moving in the severely contaminated area.

In addition, the second ending line La2 may be an imaginary line provided at a predetermined distance interval from the second starting line Ls2 and disposed in parallel with the second starting line Ls2. Further, the second connection lines Lc2 may be imaginary lines that connect the second starting line Ls2 and the second ending line La2.

Further, although not illustrated, in the divided region setting step S130, the control part 110 may further set a third divided region A3 that at least partially overlaps the first divided region A1 or the second divided region A2 in accordance with the embodiment (S133).

Meanwhile, the description of the step S133 of setting the third divided region A3 may be replaced with the description of the step S132 of setting the second divided region A2.

Further, in the divided region setting step S130, the control part 110 may set a fourth divided region A4, a fifth divided region A5, and the like in the above-mentioned manner.

Therefore, in the divided region setting step S130, the control part 110 may set the plurality of divided regions A1, A2, . . . , and An by dividing the cleaning region A, and the plurality of divided regions Al, A2, . . . , and An may be set to at least partially overlap one another (see FIG. 12).

Further, in the divided region setting step S130, the control part 110 may set the starting point Ps at which the robot cleaner 1 starts the movement step S300 to be described below.

In the divided region setting step S130, the control part 110 may set a predetermined point in the first divided region A1 as the starting point Ps. For example, in the divided region setting step S130, the control part 110 may set any one of two points at which the first starting line Ls1 is connected to the first connection lines Lc1 as the starting point Ps. That is, in the divided region setting step S130, the control part 110 may set a point corresponding to an edge of the first divided region A1 having a rectangular shape as the starting point Ps. With the above-mentioned configuration, the robot cleaner 1 starts to rectilinearly move along any one of the pair of first connection lines Lc1 at the time of starting the movement step S300, such that the robot cleaner 1 may precisely clean an outer periphery of the cleaning region A.

Next, in the movement preparation step S200, the control part 110 may dispose the robot cleaner 1 at the starting point Ps.

In a case in which the robot cleaner 1 is not positioned at the starting point Ps, the control part 110 may control and move the robot cleaner 1 to the starting point Ps. Meanwhile, when the robot cleaner 1 is positioned at the starting point Ps, the control part 110 may perform control so that a front surface 51 of the main body 50 is directed toward an initial direction change point Pt1. The initial direction change point Pt1 is present on the first ending line La1, and an imaginary line connecting the starting point Ps and the initial direction change point Pt1 may be orthogonal to the first starting line Ls1 and/or the first ending line La1.

For example, the control part 110 may perform control so that the movement direction line H of the robot cleaner 1 is directed toward the initial direction change point Pt1. Specifically, the control part 110 may calculate an angle difference between the movement direction line H and the initial direction change point Pt1 and operate the first motor 56 and/or the second motor 57 to rotate the robot cleaner 1 by the angle difference so that the movement direction line H and the initial direction change point Pt1 are coincident with each other.

In this case, the control part 110 may operate the first motor 56 and the second motor 57 in the same rotation direction and at the same rotational velocity to rotate the robot cleaner 1 in place. That is, the first rotary plate 10 and the second rotary plate 20 may rotate the robot cleaner 1 in place while rotating in the equal rotation direction and at the equal rotational velocity.

Meanwhile, in the embodiment, the control part 110 may perform control for compensating for slippage when the robot cleaner 1 slips when rotating in place. Further, when the front surface 51 of the main body 50 is directed toward the initial direction change point Ptl, the control part 110 may start the movement step S300.

In the movement step S300, the control part 110 may control and move the robot cleaner 1 in the cleaning region A.

Specifically, in the movement step S300, the robot cleaner may move in the plurality of divided regions A1, A2, . . . , and An. In this case, the control part 110 may set the order of the plurality of divided regions A1, A2, . . . , and An, and the robot cleaner may move in the plurality of divided regions A1, A2, . . . , and An in accordance with the order.

For example, in the case in which the cleaning region A is divided into the first divided region A1 and the second divided region A2 in the region setting step S100, the robot cleaner A may move in the first divided region A1 and then move in the second divided region A2 in the movement step S300.

The movement step S300 may include a first region movement step S310 and a second region movement step S330.

In the first region movement step S310, the robot cleaner 1 may move in any one of the divided regions A1, A2, . . . , and An. For example, in the first region movement step S310, the robot cleaner 1 may move in the first divided region A1. In this case, in the first region movement step S310, the control part 110 may allow the robot cleaner 1 to start from the starting point Ps and move to a first ending point Pal. In this process, the control part 110 may repeat a forward movement and a rotation of the robot cleaner 1 multiple times.

In this case, the starting point Ps may be positioned at any one of the edges of the first divided region A1 having a rectangular shape, and the first ending point Pa1 may be an edge of the first divided region A1 positioned on a diagonal line from the starting point Ps.

Specifically, the first region movement step S310 may include a first forward movement step S311, a first direction change step S312, a second forward movement step S313, and a second direction change step S314.

In the first forward movement step S311, the control part 110 may move the robot cleaner 1 from the first starting line Ls1 to the first ending line La1. Specifically, in the first forward movement step S311, the robot cleaner 1 may start from one point on the predetermined first starting line Ls1 and move forward to one point on the predetermined first ending line La1. In this case, the point on the first ending line La1 may be disposed at the shortest distance from the point on the first starting line Ls1. That is, in the first forward movement step S311, the robot cleaner 1 may move forward from the first starting line Ls1 to the first ending line La1 in the direction perpendicular to the first starting line Ls1.

For example, after the movement preparation step S200, the robot cleaner 1 may start from the starting point Ps and move to the initial direction change point Pt1 on the first ending line La1.

As another example, after the first forward movement step S311, the first direction change step S312, the second forward movement step S313, and second direction change step S314 are repeated multiple times n, the robot cleaner 1 may start from any one point ((n+1)th point) on the first starting line Ls1 and move to any one point ((n+1)th point) on the first ending line La1.

In the first forward movement step S311, when the robot cleaner 1 starts to move, the control part 110 may rotate the first motor 56 and the second motor 57 in opposite directions. For example, the robot cleaner 1 may move forward when the first rotary plate 10 rotates counterclockwise and the second rotary plate 20 rotates clockwise when viewed from above the ground surface.

For example, in the first forward movement step S311, the control part 110 may move the robot cleaner rectilinearly from the first starting line Ls1 to the first ending line La1. In this case, the first rotary plate 10 and the second rotary plate 20 may be rotated in opposite directions, and a rotational velocity 0)1 of the first rotary plate 10 and a rotational velocity ω2 of the second rotary plate 20 may be equal to each other (ω1=ω2).

That is, in the first forward movement step S311, the control part 110 may operate the first motor 56 and the second motor 57 with the same output. Further, in the first forward movement step S311, a relative movement velocity v1 of the first mop 30 to the floor surface B may be equal to a relative movement velocity v2 of the second mop 40 to the floor surface B (v1=v2).

In the first forward movement step S311, the control part 110 may stop the movement of the robot cleaner 1 based on a distance from the first starting line Ls1 detected by the displacement sensor 126. For example, in the first forward movement step S311, the control part 110 may stop the movement of the robot cleaner 1 when a distance from the first starting line Ls1 to the robot cleaner 1 detected by the displacement sensor 126 is equal to the first distance D1. As another example, in the first forward movement step S311, the control part 110 may stop the movement of the robot cleaner 1 when the control part 110 detects a coordinate of the robot cleaner 1 and determines that the robot cleaner 1 has reached the first ending line La1.

Meanwhile, in the first forward movement step S311, when the obstacle o is detected while the robot cleaner 1 moves, the first direction change step S312 may be performed. Specifically, the sensor part 120 may detect whether the robot cleaner 1 collides with an obstacle while the robot cleaner 1 moves or whether an obstacle is present in a predetermined distance range in a forward direction of the robot cleaner 1. In this case, when the control part 110 receives, from the sensor part 120, a signal indicating that an obstacle is detected, the control part 110 may stop the movement of the robot cleaner 1. In this case, the first direction change step S312 may be performed even though the robot cleaner 1 has not reached the first ending line La1 (see FIG. 13A).

In the first direction change step S312, the control part 110 may rotate the robot cleaner 1 on the first ending line La1 toward the first starting line Ls1 after the first forward movement step S311.

In the first direction change step S312, the control part 110 may rotate the robot cleaner 1. That is, the robot cleaner 1 may move to the first ending line La1 in the first forward movement step S311 and then rotate in the first direction change step S312. Specifically, in the first direction change step S312, the robot cleaner 1 may rotate in a state of being stationary on the floor surface. That is, in the first direction change step S312, the control part 110 may control and operate the first motor 56 and the second motor 57 in the same direction. In this case, the pair of rotary plates 10 and 20 may rotate in the same direction. Therefore, the first mop 30 and the second mop 40 may rotate in the same direction.

For example, in order to rotate the robot cleaner 1 counterclockwise when viewed from the top side perpendicular to the ground surface (floor surface), the control part 110 may operate the first motor 56 and the second motor 57 to rotate the first rotary plate 10 and the second rotary plate 20 clockwise. Therefore, the first mop 30 and the second mop 40 rotate clockwise together with the first rotary plate 10 and the second rotary plate 20 and relatively rotate while generating friction with the floor surface B, thereby rotating the robot cleaner 1 counterclockwise.

As another example, in order to rotate the robot cleaner 1 clockwise when viewed from the top side perpendicular to the ground surface (floor surface), the control part 110 may operate the first motor 56 and the second motor 57 to rotate the first rotary plate 10 and the second rotary plate 20 counterclockwise. Therefore, the first mop 30 and the second mop 40 rotate counterclockwise together with the first rotary plate 10 and the second rotary plate 20 and relatively rotate while generating friction with the floor surface B, thereby rotating the robot cleaner 1 clockwise.

In the first direction change step S312, the control part 110 may rotate the pair of rotary plates 10 and 20 at the same velocity (ω1=ω2) at the time of initiating the rotation. That is, in the direction change step S40, the control part 110 may operate the first motor 56 and the second motor 57 with the same output. Further, in the direction change step S40, the relative movement velocity v1 of the first mop 30 to the floor surface B may be equal in magnitude (absolute value) to the relative movement velocity v2 of the second mop 40 to the floor surface B.

On the contrary, in the first direction change step S312, the robot cleaner 1 may rotate while moving on the floor surface. That is, in the first direction change step S312, the control part 110 may control the first motor 56 and the second motor 57 to rotate the pair of rotary plates 10 and 20 in opposite directions or the same direction in such a way that the rotational velocities of the pair of rotary plates 10 and 20 are different from each other. In this case, the robot cleaner 1 may rotate while forming an arc on the floor surface.

In the first direction change step S312, the control part 110 may rotate the robot cleaner 1 toward the first starting line Ls1.

Specifically, after the first forward movement step S311, the robot cleaner 1 is positioned on the first ending line La1 that defines a boundary of the first divided region A1. At this point in time, the front surface 51 of the main body 50 of the robot cleaner 1 is directed toward the outside of the first divided region Al. That is, at a point in time at which the first forward movement step S311 is ended, the front surface 51 of the main body 50 is directed toward a portion distant from the first starting line Ls1.

Further, in the first direction change step S312, the control part 110 may rotate the main body 50 of the robot cleaner 1 by a preset first direction change angle 01 based on a direction in which the front surface 51 of the main body 50 of the robot cleaner 1 is directed.

In this case, the direction in which the robot cleaner 1 rotates may be a direction in which the robot cleaner 1 moves away from the first connection line Lc1 that the robot cleaner 1 abuts at the starting point Ps. For example, in a case in which the first connection line Lc1 is present at the left side of the robot cleaner 1 at the starting point Ps1 and the first direction change point Pt1, the control part 110 may rotate the robot cleaner 1 clockwise or counterclockwise so that the front surface of the robot cleaner 1 is directed toward the right side in the first direction change step S312.

In the first direction change step S312, the robot cleaner 1 may be rotated by the predetermined first direction change angle θ1.

In this case, the first direction change angle θ1 may be, but not limited to, 135 degrees or more and 180 degrees or less or may include various angles that allow a region on the floor surface B to be cleaned by the robot cleaner 1 in the first forward movement step S311 to overlap a region on the floor surface B to be cleaned by the robot cleaner 1 in the second forward movement step S313 to be described below.

As a result, in the first direction change step S312, the main body 50 may be rotated so that the front surface 51 of the main body 50, which is directed toward the outside of the first divided region A1 in the state in which the first forward movement step S311 is ended, is directed toward the first starting line Ls1 (see FIG. 13B).

In the second forward movement step S313, the control part 110 may move the robot cleaner 1 from the first ending line La1 to the first starting line Ls1. Specifically, in the second forward movement step S313, the robot cleaner 1 may start from one point on the predetermined first ending line La1 and move forward to one point on the predetermined first starting line Ls1.

In this case, the point on the first starting line Ls1 that the robot cleaner 1 reaches in the second forward movement step S313 may be different from the point on the first starting line Ls1 from which the robot cleaner 1 starts in the first forward movement step S311.

Specifically, the point on the first starting line Ls1 that the robot cleaner 1 reaches in the second forward movement step S313 and the point on the first starting line Ls1 from the robot cleaner 1 starts in the previous first forward movement step S311 may be disposed at a predetermined interval on the first starting line Ls1. For example, when a diameter of the robot cleaner 1 is R, the two points may be disposed at an interval of 0.5R or more and R or less.

With the above-mentioned configuration, the region in which the robot cleaner 1 performs the cleaning operation while moving in the second forward movement step S313 may partially overlap the region in which the robot cleaner 1 performs the cleaning operation while moving in the first forward movement step S311. Therefore, the robot cleaner 1 may precisely and repeatedly clean the cleaning region A.

In the second forward movement step S313, when the robot cleaner 1 starts to move, the control part 110 may rotate the first motor 56 and the second motor 57 in opposite directions. For example, the robot cleaner 1 may move forward when the first rotary plate 10 rotates counterclockwise and the second rotary plate 20 rotates clockwise when viewed from above the ground surface.

For example, in the second forward movement step S313, the control part 110 may move the robot cleaner rectilinearly from the first starting line Ls1 to the first ending line La1. In this case, the first rotary plate 10 and the second rotary plate 20 may be rotated in opposite directions, and the rotational velocity col of the first rotary plate 10 and the rotational velocity ω2 of the second rotary plate 20 may be equal to each other (ω1−ω2=Δω). That is, in the first forward movement step S311, the control part 110 may operate the first motor 56 and the second motor 57 with the same output. Further, in the second forward movement step S313, the relative movement velocity v1 of the first mop 30 to the floor surface B may be equal to the relative movement velocity v2 of the second mop 40 to the floor surface B (v1=v2) (see FIG. 13C).

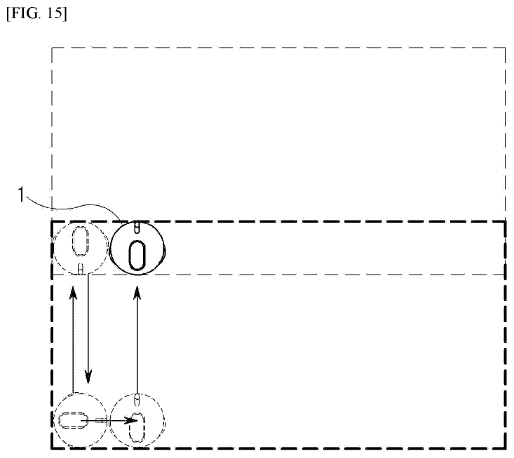

As another example, the control part 110 may move the robot cleaner 1 from the first starting line Ls1 to the first ending line La1 along a route having a predetermined curvature. In this case, the first rotary plate 10 and the second rotary plate 20 may rotate in opposite directions in such a way that the rotational velocities of the first rotary plate 10 and the second rotary plate 20 are different from each other. In this case, a difference (ω1−ω2=Δω) in rotational velocities between the first rotary plate 10 and the second rotary plate 20 may be constant (see FIG. 15).

In the second forward movement step S313, the control part 110 may stop the movement of the robot cleaner 1 based on a distance from the first ending line La1 detected by the displacement sensor 126. For example, in the second forward movement step S313, the control part 110 may stop the movement of the robot cleaner 1 when a distance from the first ending line La1 to the robot cleaner 1 detected by the displacement sensor 126 is equal to the first distance D1. As another example, in the second forward movement step S313, the control part 110 may stop the movement of the robot cleaner 1 when the control part 110 detects a coordinate of the robot cleaner 1 and determines that the robot cleaner 1 has reached the first starting line Ls1.

Meanwhile, in the second forward movement step S313, when the obstacle o is detected while the robot cleaner 1 moves, the second direction change step S314 may be performed. Specifically, the sensor part 120 may detect whether the robot cleaner 1 collides with an obstacle while the robot cleaner 1 moves or whether an obstacle is present in a predetermined distance range in the forward direction of the robot cleaner 1. In this case, when the control part 110 receives, from the sensor part 120, a signal indicating that an obstacle is detected, the control part 110 may stop the movement of the robot cleaner 1. In this case, the second direction change step S314 may be performed even though the robot cleaner 1 has not reached the first starting line Ls1 (see FIG. 13F).

In the second direction change step S314, the control part 110 may rotate the robot cleaner 1 on the first starting line Ls1 toward the first ending line La1 after the second forward movement step S313.

In the second direction change step S314, the control part 110 may rotate the robot cleaner 1. That is, the robot cleaner 1 may move to the first starting line Ls1 in the second forward movement step S313 and then rotate in the second direction change step S314.

Specifically, in the second direction change step S314, the robot cleaner 1 may rotate in a state of being stationary on the floor surface. That is, in the second direction change step S314, the control part 110 may control and operate the first motor 56 and the second motor 57 in the same direction. In this case, the pair of rotary plates 10 and 20 may rotate in the same direction. Therefore, the first mop 30 and the second mop 40 may rotate in the same direction.

For example, in order to rotate the robot cleaner 1 counterclockwise when viewed from the top side perpendicular to the ground surface (floor surface), the control part 110 may operate the first motor 56 and the second motor 57 to rotate the first rotary plate 10 and the second rotary plate 20 clockwise. Therefore, the first mop 30 and the second mop 40 rotate clockwise together with the first rotary plate 10 and the second rotary plate 20 and relatively rotate while generating friction with the floor surface B, thereby rotating the robot cleaner 1 counterclockwise.

As another example, in order to rotate the robot cleaner 1 clockwise when viewed from the top side perpendicular to the ground surface (floor surface), the control part 110 may operate the first motor 56 and the second motor 57 to rotate the first rotary plate 10 and the second rotary plate 20 counterclockwise. Therefore, the first mop 30 and the second mop 40 rotate counterclockwise together with the first rotary plate 10 and the second rotary plate 20 and relatively rotate while generating friction with the floor surface B, thereby rotating the robot cleaner 1 clockwise.

In the second direction change step S314, the control part 110 may rotate the pair of rotary plates 10 and 20 at the same velocity (ω1=ω2) at the time of initiating the rotation. That is, in the second direction change step S314, the control part 110 may operate the first motor 56 and the second motor 57 with the same output. Further, in the second direction change step S314, the relative movement velocity vl of the first mop 30 to the floor surface B may be equal in magnitude (absolute value) to the relative movement velocity v2 of the second mop 40 to the floor surface B.

On the contrary, in the second direction change step S314, the robot cleaner 1 may rotate while moving on the floor surface. That is, in the second direction change step S314, the control part 110 may control the first motor 56 and the second motor 57 to rotate the pair of rotary plates 10 and 20 in opposite directions or the same direction in such a way that the rotational velocities of the pair of rotary plates 10 and 20 are different from each other. In this case, the robot cleaner 1 may rotate while forming an arc on the floor surface.

In the second direction change step S314, the control part 110 may rotate the robot cleaner 1 toward the first ending line La1.

Specifically, after the second forward movement step S313, the robot cleaner 1 is positioned on the first starting line Ls1 that defines a boundary of the first divided region A1. At this point in time, the front surface 51 of the main body 50 of the robot cleaner 1 is directed toward the outside of the first divided region A1. That is, at a point in time at which the second forward movement step S313 is ended, the front surface 51 of the main body 50 is directed toward a portion distant from the first ending line La1.

Meanwhile, a rotation angle of the robot cleaner 1 in the first direction change step S312 may be equal to a rotation angle of the robot cleaner 1 in the second direction change step S314, whereas a rotation direction of the robot cleaner 1 in the first direction change step S312 may be opposite to a rotation direction of the robot cleaner 1 in the second direction change step S314.

That is, in the second direction change step S314, the control part 110 may rotate the main body 50 of the robot cleaner 1 by the preset first direction change angle θ1 based on a direction in which the front surface 51 of the main body 50 of the robot cleaner 1 is directed.

Further, when the robot cleaner 1 has rotated clockwise in the first direction change step S312, the robot cleaner 1 may rotate counterclockwise in the second direction change step S314. When the robot cleaner 1 has rotated counterclockwise in the first direction change step S312, the robot cleaner 1 may rotate clockwise in the second direction change step S314.

As a result, in the second direction change step S314, the main body 50 may be rotated so that the front surface 51 of the main body 50, which is directed toward the outside of the first divided region A1 in the state in which the second forward movement step S313 is ended, is directed toward the first ending line La1 (see FIG. 13D).

Meanwhile, in the method of controlling the robot cleaner according to the embodiment of the present disclosure, when the robot cleaner 1 reaches the first connection line Lc1, the robot cleaner 1 may perform the first forward movement step S311, end the first region movement step S310, and then perform a second region movement step S320.

Specifically, the control part 110 may determine whether the robot cleaner 1 has reached the first connection line Lc1 based on the distance from the first connection line Lc1 which is detected by the sensor part 120.

For example, in the second forward movement step S313 or the second direction change step S314, the control part 110 may detect the coordinate of the robot cleaner 1 and determine that the robot cleaner 1 has reached the first connection line Lc1. Alternatively, in the second direction change step S314, the control part 110 may detect a distance from an obstacle including a wall surface or the like by means of the sensor part 120 and determine that the robot cleaner 1 has reached the first connection line Lc1 when the distance from the obstacle is within a predetermined distance range. Alternately, in the second forward movement step S313, when the control part 110 detects, from the sensor part 120, that the robot cleaner 1 has collided with an obstacle, the control part 110 may determine that the robot cleaner 1 has reached the first connection line Lc1.

Further, when the control part 110 determines that the robot cleaner 1 has reached the first connection line Lc1, the control part 110 may perform the first forward movement step S311 and then stop the robot cleaner 1 on the first ending line La1. In this state, the control part 110 may end the first region movement step S310 and perform the second region movement step S320 to be described below.

Meanwhile, when the control part 110 determines that the robot cleaner 1 has not reached the first connection line Lc1, the control part 110 may repeatedly perform the first region movement step S310 after the second direction change step S314. That is, when the robot cleaner 1 does not reach the first connection line Lc1, the robot cleaner 1 may repeatedly and sequentially perform the first forward movement step S311, the first direction change step S312, the second forward movement step S313, and the second direction change step S314 (see FIG. 13F).

In the second region movement step S330, the control part 110 may move the robot cleaner 1 in another region, among the divided regions A1, A2, . . . , and An, which is different from the region in which the robot cleaner 1 has moved in the first region movement step S310. For example, in the second region movement step S330, the robot cleaner 1 may move in the second divided region A2. In this case, in the second region movement step S330, the control part 110 may allow the robot cleaner 1 to start from a second starting point Ps2 to a second ending point Pa2. In this process, the control part 110 may repeat the forward movement and the rotation of the robot cleaner 1 multiple times.

In this case, the second starting point Ps2 may be positioned at any one edge of the second divided region A2 having a rectangular shape, and the second ending point Pa2 may be an edge of the second divided region A2 positioned on a diagonal line from the second starting point Ps2.

In the second region movement step S330, the robot cleaner 1 may start to move in a region Ao in which the divided regions A1, A2, . . . , An overlap one another.

For example, in the second region movement step S330, the robot cleaner 1 may start to move from a point at which the first region movement step S310 is ended. That is, in the present embodiment, the first ending point Pal and the second starting point Ps2 may be identical to each other.

With this configuration, the robot cleaner 1 may perform the second region movement step S330 immediately after the first region movement step S310 is ended, thereby reducing the overall time for which the robot cleaner 1 moves in the cleaning region A.

The second region movement step S330 may include a first forward movement step S331, a first direction change step S332, a second forward movement step S333, and a second direction change step S334. Meanwhile, in order to avoid the repeated description, the description of the first forward movement step S331, the first direction change step S332, the second forward movement step S333, and the second direction change step S334 of the second region movement step S330 may be replaced with the description of the first forward movement step S311, the first direction change step S312, the second forward movement step S313, and the second direction change step S314 of the first region movement step S310, except for the contents particularly described.

In the first forward movement step S331, the control part 110 may move the robot cleaner 1 from the second starting line Ls2 to the second ending line La2. Specifically, in the first forward movement step S331, the robot cleaner 1 may start from any one point on the predetermined second starting line Ls2 and move forward to one point on the predetermined second ending line La2. In this case, the point on the second ending line La2 may be disposed at the shortest distance from the point on the second starting line Ls2.

In the first direction change step S332, the control part 110 may rotate the robot cleaner 1 on the second ending line La2 toward the second starting line Ls2 after the first forward movement step S331.

In the first direction change step S332, the robot cleaner 1 may be rotated by a predetermined second direction change angle θ2.

In this case, the second direction change angle θ2 may be, but not limited to, 135 degrees or more and 180 degrees or less or may include various angles that allow a region on the floor surface B to be cleaned by the robot cleaner 1 in the first forward movement step S331 to overlap a region on the floor surface B to be cleaned by the robot cleaner 1 in the second forward movement step S333 to be described below.

Meanwhile, when the robot cleaner 1 starts to move from the point at which the first region movement step S310 is ended, a direction in which the robot cleaner 1 rotates in the first direction change step S332 of the second region movement step S330 may be opposite to a direction in which the robot cleaner 1 rotates in the first direction change step S312 of the first region movement step S310.

In the second forward movement step S333, the control part 110 may move the robot cleaner 1 from the first ending line La1 to the second starting line Ls2. Specifically, in the second forward movement step S333, the robot cleaner 1 may start from one point on the predetermined second ending line La2 and move forward to one point on the predetermined second starting line Ls2.

In this case, the point on the second starting line Ls2 that the robot cleaner 1 reaches in the second forward movement step S333 may be different from the point on the second starting line Ls2 from which the robot cleaner 1 starts in the first forward movement step S331.

With the above-mentioned configuration, the region in which the robot cleaner 1 performs the cleaning operation while moving in the second forward movement step S333 may partially overlap the region in which the robot cleaner 1 performs the cleaning operation while moving in the first forward movement step S331. Therefore, the robot cleaner 1 may precisely and repeatedly clean the cleaning region A.

In the second forward movement step S333, the control part 110 may stop the movement of the robot cleaner 1 depending on a distance from the second ending line La2 which is detected by the displacement sensor 126.

Meanwhile, in the second forward movement step S333, when the obstacle o is detected while the robot cleaner 1 moves, the second direction change step S334 may be performed.

In the second direction change step S334, the control part 110 may rotate the robot cleaner 1 on the second starting line Ls2 toward the second ending line La2 after the second forward movement step S333.

A rotation angle of the robot cleaner 1 in the first direction change step S332 may be equal to a rotation angle of the robot cleaner 1 in the second direction change step S334, whereas a rotation direction of the robot cleaner 1 in the first direction change step S332 may be opposite to a rotation direction of the robot cleaner 1 in the second direction change step S334.

That is, in the second direction change step S334, the control part 110 may rotate the main body 50 of the robot cleaner 1 by the preset second direction change angle 02 based on the direction in which the front surface 51 of the main body 50 of the robot cleaner 1 is directed.

In addition, when the robot cleaner 1 starts to move from the point at which the first region movement step S310 is ended, a direction in which the robot cleaner 1 rotates in the second direction change step S334 of the second region movement step S330 may be opposite to a direction in which the robot cleaner 1 rotates in the second direction change step S314 of the first region movement step S310.

Meanwhile, in the second direction change step S334, the position at which the robot cleaner 1 rotates may be disposed in the first divided region A1. That is, in the second direction change step S334, the region in which the first mop 30 and the second mop 40 of the robot cleaner 1 clean the floor surface B may overlap the region in which the robot cleaner 1 cleans the floor surface B in the first region movement step S310.

With the above-mentioned configuration, the first divided region A1 and the second divided region A2 may overlap each other in the particular region of the floor surface B, and the robot cleaner 1 may repeatedly clean the first divided region A1 and the second divided region A2. Therefore, the control part 110 may set a severely contaminated portion to the region in which the first divided region A1 and the second divided region A2 overlap each other and allow the robot cleaner 1 to precisely clean the severely contaminated floor surface while repeatedly moving on the severely contaminated floor surface.

Meanwhile, when the control part 110 determines that the robot cleaner 1 has not reached the second connection line Lc2, the control part 110 may repeatedly perform the second region movement step S330 after the second direction change step S334. That is, when the robot cleaner 1 does not reach the second connection line Lc2, the robot cleaner 1 may repeatedly and sequentially perform the first forward movement step S331, the first direction change step S332, the second forward movement step S333, and the second direction change step S334.

Meanwhile, in the method of controlling the robot cleaner according to the embodiment of the present disclosure, when the robot cleaner 1 reaches the second connection line Lc2, the robot cleaner 1 may perform the first forward movement step S331 and then ends the second region movement step S330.

Specifically, the control part 110 may determine whether the robot cleaner 1 has reached the second connection line Lc2 based on the distance from the second connection line Lc2 which is detected by the sensor part 120.

For example, in the second forward movement step S333 or the second direction change step S334, the control part 110 may detect the coordinate of the robot cleaner 1 and determine that the robot cleaner 1 has reached the second connection line Lc2. Alternatively, in the second direction change step S334, the control part 110 may detect a distance from an obstacle including a wall surface or the like by means of the sensor part 120 and determine that the robot cleaner 1 has reached the second connection line Lc2 when the distance from the obstacle is within a predetermined distance range.

Alternately, in the second forward movement step S333, when the control part 110 detects, from the sensor part 120, that the robot cleaner 1 has collided with an obstacle, the control part 110 may determine that the robot cleaner 1 has reached the second connection line Lc2.

Further, when the control part 110 determines that the robot cleaner 1 has reached the second connection line Lc2, the control part 110 may perform the first forward movement step S331 and then stop the robot cleaner 1 on the second ending line La2.

Meanwhile, the method of controlling the robot cleaner according to the present disclosure is described as including the movement step S300 including the first region movement step S310 and the second region movement step S330, but the present disclosure is not limited thereto. As another embodiment, the movement step S300 may further include a third region movement step S350, a fourth region movement step S370, and the like.

In this case, in the third region movement step S350, the robot cleaner 1 may move in the third divided region A3 that at least partially overlaps the first divided region

A1 or the second divided region A2.

In addition, in the fourth region movement step S370, the robot cleaner 1 may move in the fourth divided region A4 that at least partially overlaps the first divided region A1, the second divided region A2, or the third divided region A3.

Meanwhile, the description of the third region movement step S350 and/or the fourth region movement step S370 may be replaced with the description of the second region movement step S330.

With the above-mentioned configuration, the robot cleaner 1 may set and precisely clean the plurality of divided regions even though the cleaning region A has a complicated flat surface shape. Even though a plurality of severely contaminated regions exists in the cleaning region A, the robot cleaner 1 may set the region having the divided regions overlapping one another and precisely and repeatedly clean the region.

Meanwhile, when the movement and/or the cleaning operation are ended in the cleaning region, the control part 110 may move the robot cleaner 1 to a preset position. For example, when the movement step S300 is ended, the control part 110 may control and move the robot cleaner 1 to a charging stand (not illustrated) for the robot cleaner.

An effect of the method of controlling the robot cleaner according to the embodiment of the present disclosure will be described below.

According to the method of controlling the robot cleaner according to the embodiment of the present disclosure, in the region setting step S100, the cleaning region A is divided into the plurality of divided regions A1, A2, A3, . . . , and An, and the plurality of divided regions A1, A2, A3, . . . , and An at least partially overlap one another.

Further, in the movement step S300, the robot cleaner 1 moves sequentially in the plurality of divided regions A1, A2, A3, . . . , and An.

Therefore, according to the present disclosure, it is possible to clean the entire range of the cleaning region A and repeatedly clean the particular region in which the plurality of divided regions A1, A2, A3, . . . , and An overlap one another.

In addition, in the region setting step S100, a location with a high degree of contamination is set to have the plurality of divided regions A1, A2, A3, . . . , and An overlapping one another. In the movement step S300, the robot cleaner is controlled to move repeatedly in the severely contaminated location, such that the severely contaminated floor surface may be precisely cleaned.

In addition, in the movement step S300 in which the robot cleaner cleans the floor surface while moving in the divided regions A1, A2, A3, . . . , and An each having a rectangular shape, the robot cleaner starts to move from one edge of the rectangular shape and moves to the edge on the diagonal line. Therefore, it is possible to optimize a movement route of the robot cleaner 1 and reduce the time required to clean the entire cleaning region A and repeatedly clean the portion with a high degree of contamination.

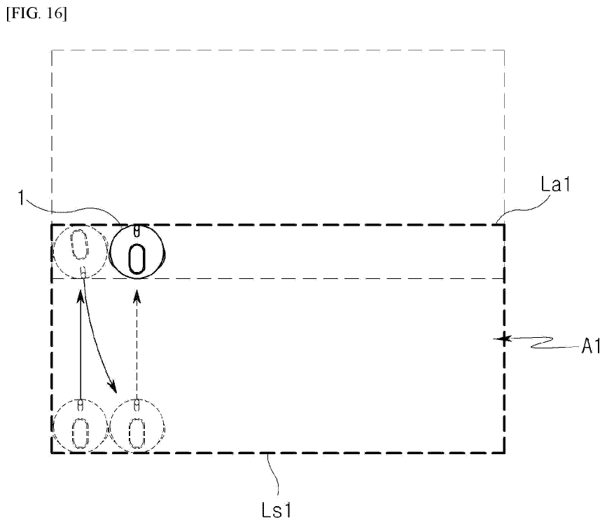

Meanwhile, FIG. 16 is a view for explaining a process in which the robot cleaner 1 moves and rotates in accordance with a method of controlling the robot cleaner according to another embodiment of the present disclosure.

The method of controlling the robot cleaner according to another embodiment of the present disclosure will be described below with reference to FIGS. 10 and 16.

Meanwhile, in order to avoid the repeated description, the description of the method of controlling the robot cleaner according to the embodiment of the present disclosure may be applied except for the components particularly described in the present embodiment.

In the present embodiment, the first region movement step S310 may include the first forward movement step S311, the first direction change step S312, the second forward movement step S313, the second direction change step S314, a third forward movement step S315, and a third direction change step S316.

In the first forward movement step S311, the control part 110 may move the robot cleaner 1 from the first starting line Ls1 to the first ending line La1.

Further, in the first direction change step S312, the control part 110 may rotate the robot cleaner 1 on the first ending line La1 by 180 degrees.

In the second forward movement step S313, the control part 110 may move the robot cleaner 1 from the first ending line La1 to the first starting line Ls1. In this case, the point on the first starting line Ls1 that the robot cleaner 1 reaches in the second forward movement step S313 is identical to the point on the first starting line Ls1 from which the robot cleaner 1 starts in the first forward movement step S311.

With the above-mentioned configuration, the region in which the robot cleaner 1 performs the cleaning operation while moving in the second forward movement step S313 may overlap the region in which the robot cleaner 1 performs the cleaning operation while moving in the first forward movement step S311. Therefore, the robot cleaner 1 may precisely and repeatedly clean the cleaning region A.

In the second direction change step S314, the control part 110 may rotate the robot cleaner 1 on the first starting line Ls1 by 90 degrees after the second forward movement step S313. In this case, the rotation direction of the robot cleaner 1 may be a direction in which the robot cleaner 1 moves away from the first connection line Lc1 on which the robot cleaner 1 is positioned at the time of starting the first region movement step S310.

In the third forward movement step S315, the control part 110 may rectilinearly move the robot cleaner 1 by a predetermined distance. For example, when the diameter of the robot cleaner 1 is R, the control part 110 may rectilinearly move the robot cleaner 1 by a distance of 0.5R or more and R or less in the third forward movement step S315. With the above-mentioned configuration, the cleaning region A may be repeatedly and precisely cleaned.

In the third direction change step S316, the control part 110 may rotate the robot cleaner 1 on the first starting line Ls1 by 90 degrees. In this case, the rotation direction of the robot cleaner 1 may be identical to the rotation direction of the robot cleaner 1 in the second direction change step S314. Therefore, the front surface 51 of the main body 50 is directed toward the first ending line La1 after the third direction change step S316.

Meanwhile, when the control part 110 determines that the robot cleaner 1 has not reached the first connection line Lc1, the control part 110 may repeatedly perform the first region movement step S310 after the third direction change step S316. That is, when the robot cleaner 1 does not reach the second connection line Lc1, the robot cleaner 1 may repeatedly and sequentially perform the first forward movement step S311, the first direction change step S312, the second forward movement step S313, the second direction change step S314, the third forward movement step S315, and the third direction change step S316.

Meanwhile, in the method of controlling the robot cleaner according to the embodiment of the present disclosure, when the robot cleaner 1 reaches the first connection line Lc1, the robot cleaner 1 may perform the first forward movement step S311, end the first region movement step S310, and then perform a second region movement step S330.

Therefore, according to the present embodiment, the robot cleaner 1 may uniformly and repeatedly move in the cleaning region A, thereby precisely cleaning the cleaning region A.

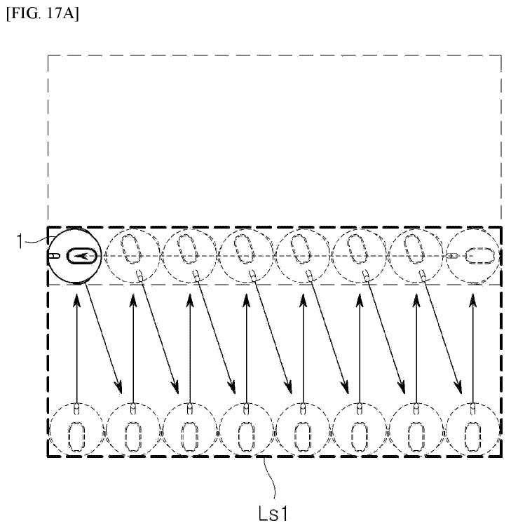

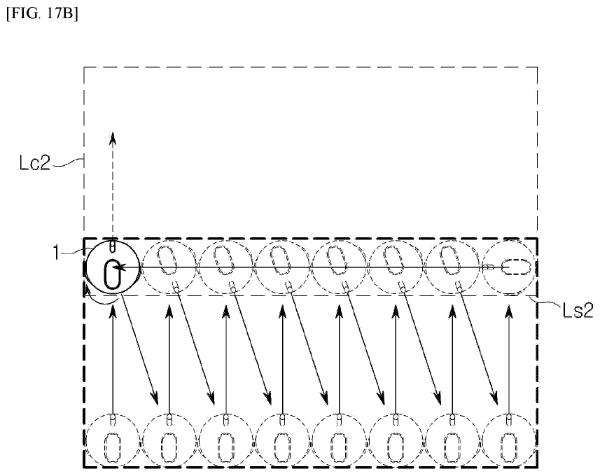

Meanwhile, FIGS. 17A and 17B are views for explaining a process in which the robot cleaner 1 starts the second region movement step S330 in accordance with a method of controlling the robot cleaner according to yet another embodiment of the present disclosure.

The method of controlling the robot cleaner according to yet another embodiment of the present disclosure will be described below with reference to FIGS. 10, 17A, and 17B.

Meanwhile, in order to avoid the repeated description, the description of the method of controlling the robot cleaner according to the embodiment of the present disclosure may be applied except for the components particularly described in the present embodiment. The present embodiment may further include a starting point change step S320 of moving the robot cleaner 1 to the second starting point Ps2 before the second region movement step S330 after the first region movement step S310 is ended.

In this case, in the present embodiment, the second starting point Ps2 may be the first direction change point Pt1 in the first region movement step S310. That is, the second starting point Ps2 is present on the first ending line La1 and positioned in a direction opposite to the direction in which the first ending point Pa1 is positioned.

Therefore, in the starting point change step S320, the control part 110 may rotate the robot cleaner 1 on the first ending point Pa1 by 90 degrees so that the front surface 51 of the main body 50 is directed toward the second starting point Ps2 (S321).

Next, the control part 110 may allow the robot cleaner 1 to start from the first ending point Pa1 and rectilinearly move to the second starting point Ps2 (S322).

Next, the control part 110 may rotate the robot cleaner 1 by 90 degrees so that the front surface of the main body 50 is directed toward the second ending line La2 (S323).

With this process, the robot cleaner 1 may move once more in the region Ao in which the divided regions A1, A2, . . . , and An overlap one another. Therefore, in the present embodiment, the robot cleaner cleans the severely contaminated region once more, thereby improving the effect of cleaning the portion required to be repeatedly cleaned, in comparison with the above-mentioned embodiment of the present disclosure.

Further, the advantage of the process in which the robot cleaner starts to move from one edge of the rectangular shape and moves to the edge of the diagonal line is maintained. As a result, it is possible to optimize the movement route of the robot cleaner 1 and reduce the time required to clean the entire cleaning region A and repeatedly clean the portion with a high degree of contamination.

While the present disclosure has been described with reference to the specific embodiments, the specific embodiments are only for specifically explaining the present disclosure, and the present disclosure is not limited to the specific embodiments. It is apparent that the present disclosure may be modified or altered by those skilled in the art without departing from the technical spirit of the present disclosure.

All the simple modifications or alterations to the present disclosure fall within the scope of the present disclosure, and the specific protection scope of the present disclosure will be defined by the appended claims.

1. A robot cleaner comprising:
a main body having a bumper provided on a front surface thereof and having a space for accommodating a battery, a water container, and a motor therein; and
a pair of rotary plates rotatably disposed on a bottom surface of the main body and having lower sides to which mops facing a floor surface are coupled,
wherein the main body moves in a predetermined first cleaning region on the floor surface and then moves in a predetermined second cleaning region, and
wherein the second cleaning region at least partially overlaps the first cleaning region.

2. The robot cleaner of claim 1, wherein the main body rotates at a position at which the first cleaning region and the second cleaning region overlap each other.

3. The robot cleaner of claim 1, wherein the first cleaning region is divided based on a boundary of an obstacle or an imaginary line on the floor surface, and
wherein the main body rotates by a predetermined direction change angle when it is detected that the main body has reached the boundary.

4. A method of controlling a robot cleaner comprising a pair of rotary plates having lower sides to which mops facing a floor surface are coupled, the robot cleaner being configured to move by rotating the pair of rotary plates, the method comprising:
a region setting step of setting a cleaning region on the floor surface; and
a movement step of moving the robot cleaner in the cleaning region,
wherein the region setting step divides the cleaning region into a plurality of divided regions, and the plurality of divided regions at least partially overlaps one another.

5. The method of claim 4, wherein the region setting step comprises:
a cleaning region setting step of setting the cleaning region on the floor surface; and
a divided region setting step of dividing the cleaning region into the plurality of divided regions.

6. The method of claim 4, wherein the region setting step sets a boundary of the cleaning region by detecting an obstacle comprising a wall and applying a position of the obstacle.

7. The method of claim 4, wherein the region setting step sets the imaginary divided region having a rectangular shape in the cleaning region.

8. The method of claim 4, wherein the region setting step sets the divided region comprising an imaginary first starting line comprising a predetermined starting position and an imaginary first ending line provided in parallel with the first starting line and disposed at a predetermined distance interval from the first starting line.

9. The method of claim 4, wherein the region setting step sets a first divided region comprising an imaginary first starting line comprising a predetermined starting position and an imaginary first ending line provided in parallel with the first starting line and disposed at a predetermined distance interval from the first starting line, and sets a second divided region comprising a second starting line overlapping the first ending line and an imaginary second ending line provided in parallel with the second starting line and disposed at a predetermined distance interval from the second starting line.

10. The method of claim 4, wherein the region setting step sets an imaginary first divided region and an imaginary second divided region in the cleaning region,
wherein the first divided region and the second divided region at least partially overlap each other, and
wherein in the movement step, the robot cleaner moves in the first divided region and then moves in the second divided region.

11. The method of claim 4, wherein the movement step comprises:
a first region movement step of moving the robot cleaner in any one of the divided regions; and
a second region movement step of moving the robot cleaner in another of the divided regions.

12. The method of claim 4, wherein the movement step comprises:
a first forward movement step of moving the robot cleaner from a predetermined first starting line to a first ending line provided in parallel with the first starting line and disposed at a predetermined distance interval from the first starting line;
a first direction change step of rotating the robot cleaner after the first forward movement step;
a second forward movement step of moving the robot cleaner from the first ending line to the first starting line; and
a second direction change step of rotating the robot cleaner after the second forward movement step.

13. The method of claim 12, wherein the first direction change step is performed when an obstacle is detected while the robot cleaner moves in the first forward movement step.

14. The method of claim 12, wherein the first direction change step rotates the robot cleaner by a predetermined direction change angle.

15. The method of claim 12, wherein a rotation angle of the robot cleaner in the first direction change step is equal to a rotation angle of the robot cleaner in the second direction change step, and
wherein a rotation direction of the robot cleaner in the first direction change step is opposite to a rotation direction of the robot cleaner in the second direction change step.

16. The method of claim 11, further comprising:
a first movement preparation step of disposing the robot cleaner at a starting point before the first region movement step.

17. The method of claim 11, wherein the second region movement step allows the robot cleaner to start to move in a region in which the divided regions overlap one another.

18. The method of claim 11, wherein the second region movement step allows the robot cleaner to start to move from a point at which the first region movement step is ended.

19. The method of claim 11, wherein the first region movement step allows the robot cleaner to start to move from a predetermined starting point and move to a first direction change point provided at a predetermined distance interval from the predetermined starting point and then repeats a rotation and a movement of the robot cleaner multiple times, and the second region movement step allows the robot cleaner to start to move from the first direction change point.
